(19) United States
(12) Patent Application Publication
(10) Pub. No.: US 2026/0193869 A1
(43) Pub. Date: Jul. 9, 2026

(54) CONSTRUCTION MACHINE

(71) Applicant: HITACHI CONSTRUCTION MACHINERY CO., LTD., Tokyo (JP)

(72) Inventors: Juri SHIMIZU, Chiyoda-ku (JP); Hajime OKANO, Tsuchiura-shi (JP); Kenji HIRAKU, Tsuchiura-shi (JP)

(21) Appl. No.: 18/867,660

(22) PCT Filed: Jul. 3, 2023
(86) PCT No.: PCT/JP2023/024679

§ 371 Date: Nov. 20, 2024

(30) Foreign Application Priority Data
Jul. 4, 2022 (JP) 2022-107432

(51) Int. Cl. E02F 9/26; E02F 9/20; E02F 9/22; F15B 13/04; F15B 19/00

(52) U.S. Cl. CPC E02F 9/268; E02F 9/2004; E02F 9/2203; E02F 9/2289; E02F 9/2292; E02F 9/2296; F15B 13/0401; F15B 19/005; F15B 2211/20576; F15B 2211/87

(57) ABSTRACT

An object of the present invention is to provide a construction machine that can suppress the lowering of the operability when a pressure sensor that measures the pressure of an actuator for driving a work device involves a failure in a case in which a closed circuit is formed between the actuator and a plurality of hydraulic pumps and the actuator is driven. For this purpose, when determining that an actuator pressure sensor involves a failure, a controller calculates pseudo-pressure of an actuator on the basis of a measurement value of a posture sensor, and calculates the differential pressure across a closed-circuit selector valve by using the pseudo-pressure instead of a measurement value of the actuator pressure sensor.

### TECHNICAL FIELD

The present invention relates to a construction machine including a hydraulic circuit that drives a hydraulic actuator by use of a hydraulic fluid delivered from a hydraulic pump.

### BACKGROUND ART

In recent years, in construction machines such as hydraulic excavators, development has been advanced for a hydraulic circuit connected in such a manner that a hydraulic operating fluid is sent from a hydraulic drive source such as a hydraulic pump to a hydraulic actuator such as a hydraulic cylinder and the hydraulic operating fluid resulting from execution of work at the hydraulic actuator is returned to the hydraulic pump without being returned to a tank (defined as closed circuit), in order to reduce restrictor elements in the hydraulic circuit that drives the hydraulic actuator to reduce the fuel consumption rate. Moreover, there has been proposed a configuration in which a pump is connected to the cap chamber side in order to compensate for difference in the pressure receiving area of a single-rod cylinder in an excavator to which the closed circuit is applied.

In these hydraulic circuits, there has been proposed a configuration that implements combined operation performed by a plurality of actuators and improvement in the speed during independent operation, by employing a configuration in which a plurality of pumps can be redundantly connected to one actuator. In such a hydraulic circuit in which the actuator as the connection destination of a pump can be changed, the connection and interruption between the pump and the actuator need to be switched. At this time, shock occurs if the differential pressure between the actuator and the pump is high. In patent document 1, a hydraulic drive system is described that connects a pump to an actuator after making the pressure difference between the actuator and the pump small.

### PRIOR ART DOCUMENT

### Patent Document

Patent Document 1: JP-2015-203453-A

### SUMMARY OF THE INVENTION

### Problem to be Solved by the Invention

In patent document 1, a pump is connected to an actuator after the actuator pressure is measured by a pressure sensor and then the pump pressure is raised to the measured actuator pressure. Thus, if the pressure sensor involves a failure, there is a possibility that shock occurs to lower the operability when the pump is connected to the actuator, due to raising of the pump pressure to a pressure different from the actual actuator pressure before the connection of the pump to the actuator.

The present invention is made in view of the above-described problem, and an object thereof is to provide a construction machine that can suppress the lowering of the operability when a pressure sensor that measures the pressure of an actuator for driving a work device involves a failure in a case in which a closed circuit is formed between the actuator and a plurality of hydraulic pumps and the actuator is driven.

### Means for Solving the Problem

In order to achieve the above-described object, the present invention provides a construction machine. The construction machine includes a work device, an actuator that drives the work device, a plurality of closed-circuit pumps of a variable displacement type having two flow-out/in ports, a plurality of closed-circuit selector valves capable of switching between communication and interruption between the actuator and the plurality of closed-circuit pumps, a posture sensor that senses the posture of the work device, a plurality of closed-circuit pump pressure sensors that sense the pressure of the plurality of closed-circuit pumps, an actuator pressure sensor that senses the pressure of the actuator, an operation device that instructs the actuator to act, and a controller that controls the plurality of closed-circuit selector valves and the plurality of closed-circuit pumps in response to an input signal from the operation device. The controller is configured to, when supply of a hydraulic operating fluid from one closed-circuit pump among the plurality of closed-circuit pumps to the actuator is started, open one closed-circuit selector valve corresponding to the one closed-circuit pump among the plurality of closed-circuit selector valves after controlling, in a state in which the one closed-circuit selector valve is closed, the one closed-circuit pump in such a manner that the differential pressure across the closed-circuit selector valve that is the difference between a measurement value of one closed-circuit pump pressure sensor corresponding to the one closed-circuit pump and a measurement value of the actuator pressure sensor becomes equal to or lower than a predetermined first threshold. The controller is configured to, in a state in which two or more closed-circuit pumps among the plurality of closed-circuit pumps are connected to the actuator, determine whether a failure of the actuator pressure sensor exists on the basis of measurement values of two or more closed-circuit pump pressure sensors corresponding to the two or more closed-circuit pumps among the plurality of closed-circuit pump pressure sensors and the measurement value of the actuator pressure sensor. The controller is configured to, when determining that the actuator pressure sensor involves a failure, calculate pseudo-pressure of the actuator on the basis of a measurement value of the posture sensor and calculate the differential pressure across the closed-circuit selector valve by using the pseudo-pressure instead of the measurement value of the actuator pressure sensor.

According to the present invention configured as above, it becomes possible to correctly determine a failure of the actuator pressure sensor on the basis of the result of comparison between the measurement value of the actuator pressure sensor and the measurement values of the two or more closed-circuit pump pressure sensors. Furthermore, when the actuator pressure sensor involves a failure, the differential pressure across the closed-circuit selector valve is calculated by using the pseudo-pressure of the actuator calculated according to the posture of the work device instead of the measurement value of the pressure sensor involving the failure. As a result, shock when the closed-circuit pump is connected to the actuator is suppressed. Thus, the lowering of the operability can be prevented.

### Advantages of the Invention

According to the construction machine in accordance with the present invention, it becomes possible to suppress the lowering of the operability when the pressure sensor that measures the pressure of the actuator for driving the work device involves a failure.

### BRIEF DESCRIPTION OF THE DRAWINGS

FIG. 1 is a side view of a hydraulic excavator in an embodiment of the present invention.

FIG. 2 is a hydraulic circuit diagram of a hydraulic drive system mounted in the hydraulic excavator in the embodiment of the present invention.

FIG. 3 is a functional block diagram of a controller in the embodiment of the present invention.

FIG. 4 is a time chart illustrating state change of the hydraulic drive system when extension action of a boom cylinder is caused in the embodiment of the present invention.

FIG. 5 is a flowchart illustrating part of processing executed by a pressure sensor failure sensing section in the embodiment of the present invention.

FIG. 6 is a diagram illustrating posture change of the hydraulic excavator when extension action of an arm cylinder is caused in the embodiment of the present invention.

FIG. 7 is a diagram illustrating the relationship between the stroke and the pressure of a cap chamber regarding the arm cylinder in the embodiment of the present invention.

FIG. 8 is a flowchart illustrating processing executed by a pressure sensor failure diagnosis input generation section in the embodiment of the present invention.

FIG. 9 is a time chart illustrating state change of the hydraulic drive system depending on the input of a pressure sensor failure diagnosis input generation device in the embodiment of the present invention.

### MODES FOR CARRYING OUT THE INVENTION

Description will be given below with reference to the drawings by taking a hydraulic excavator as an example of the construction machine according to the present invention. Note that, in the respective diagrams, an equivalent component is given the same numeral, and overlapping description is omitted as appropriate.

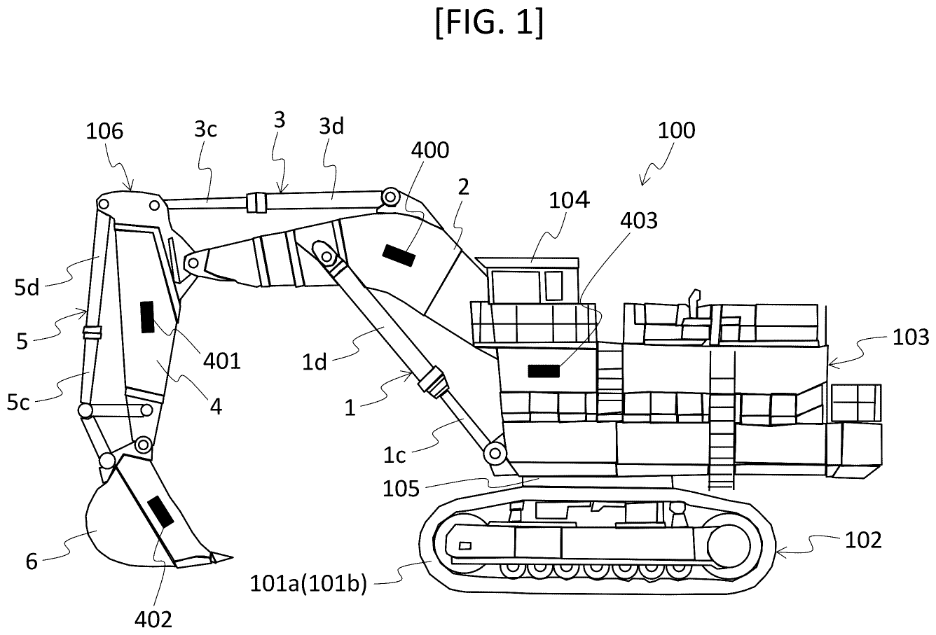

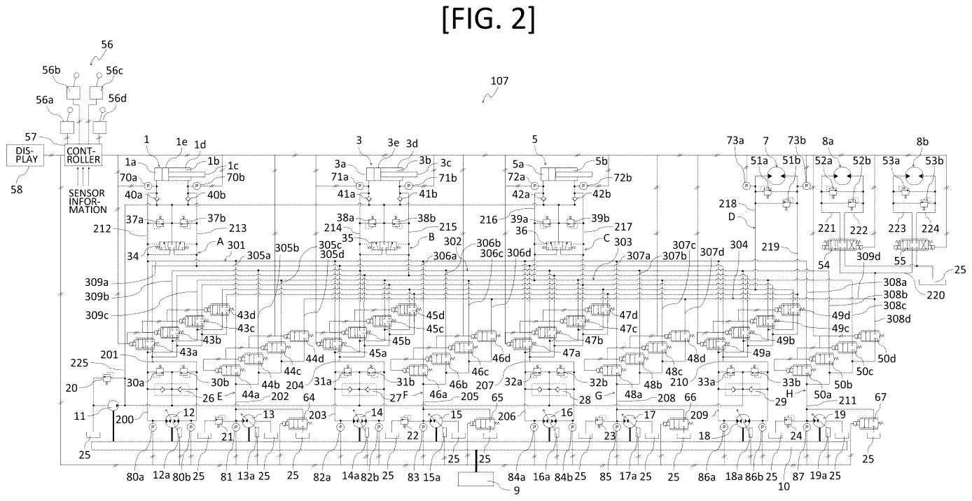

FIG. 1 is a side view of the hydraulic excavator in the present embodiment. FIG. 2 is a hydraulic circuit diagram of a hydraulic drive system mounted in the hydraulic excavator in the present embodiment.

As illustrated in FIG. 1, a hydraulic excavator 100 includes a lower track structure 102 including track devices 101a and 101b of a crawler type on both sides in the left-right direction and an upper swing structure 103 swingably attached onto the lower track structure 102. A cab 104 in which an operator rides is disposed on the upper swing structure 103. The upper swing structure 103 is swingably attached to the lower track structure 102 with the interposition of a swing device 105. The track devices 101a and 101b are driven by travelling motors 8a and 8b (illustrated in FIG. 2), and the swing device 105 is driven by a swing motor 7 (illustrated in FIG. 2).

A base end portion of a front work implement 106 that is a work device for executing, for example, excavation work is attached to the front side of the upper swing structure 103 pivotally in the upward-downward direction. The front work implement 106 includes a boom 2 having a base end portion joined to the front side of the upper swing structure 103 pivotally in the upward-downward direction. The boom 2 operates through a boom cylinder 1 that is a single-rod hydraulic cylinder driven by a hydraulic operating fluid (hydraulic fluid) as a supplied fluid. In the boom cylinder 1, a tip portion of a rod 1c is joined to the upper swing structure 103 and a base end portion of a cylinder tube 1d is joined to the boom 2.

As illustrated in FIG. 2, the boom cylinder 1 includes a cap chamber 1a that is a first hydraulic operating fluid chamber on the cap side, that is located on the base end side of the cylinder tube 1d, and that is supplied with the hydraulic operating fluid to press a piston 1e, which is attached to a base end portion of the rod 1c, to give a load based on the hydraulic operating fluid pressure to cause extension movement of the rod 1c. Furthermore, the boom cylinder 1 includes a rod chamber 1b as a second hydraulic operating fluid chamber on the rod side, that is located on the tip side of the cylinder tube 1d and is supplied with the hydraulic operating fluid to press the piston 1e to give a load based on the hydraulic operating fluid pressure to cause contraction movement of the rod 1c.

Referring back to FIG. 1, a base end portion of an arm 4 is joined to a tip portion of the boom 2 in such a manner as to be capable of being raised and lowered. The arm 4 operates through an arm cylinder 3 that is a single-rod hydraulic cylinder. In the arm cylinder 3, a tip portion of a rod 3c is joined to the arm 4 and a cylinder tube 3d of the arm cylinder 3 is joined to the boom 2.

As illustrated in FIG. 2, the arm cylinder 3 includes a cap chamber 3a that is located on the base end side of the cylinder tube 3d and is supplied with the hydraulic operating fluid to press a piston 3e attached to a base end portion of the rod 3c and cause extension movement of the rod 3c. Moreover, the arm cylinder 3 includes a rod chamber 3b that is located on the tip side of the cylinder tube 3d and is supplied with the hydraulic operating fluid to press the piston 3e and cause contraction movement of the rod 3c.

Referring back to FIG. 1, a base end portion of a bucket 6 is joined to a tip portion of the arm 4 in such a manner as to be capable of being raised and lowered. The bucket 6 operates through a bucket cylinder 5 that is a single-rod hydraulic cylinder as a hydraulic actuator driven by the supplied hydraulic operating fluid. In the bucket cylinder 5, a tip portion of a rod 5c is joined to the bucket 6 and the base end of a cylinder tube 5d of the bucket cylinder 5 is joined to the arm 4.

As illustrated in FIG. 2, the bucket cylinder 5 includes a cap chamber 5a that is located on the base end side of the cylinder tube 5d and is supplied with the hydraulic operating fluid to press a piston 5e attached to a base end portion of the rod 5c and cause extension movement of the rod 5c. Furthermore, the bucket cylinder 5 includes a rod chamber 5b that is located on the tip side of the cylinder tube 5d and is supplied with the hydraulic operating fluid to press the piston 5e and cause contraction movement of the rod 5c.

Note that each of the boom cylinder 1, the arm cylinder 3, and the bucket cylinder 5 executes extension/contraction action by the supplied hydraulic operating fluid and is driven to extend or contract according to the supply direction of this supplied hydraulic operating fluid. The hydraulic excavator 100 in the present embodiment is a backhoe excavator, and is configured in such a manner that the bucket 6 is pulled back rearward by extending the arm cylinder 3 or the bucket cylinder 5.

The boom 2 is equipped with a posture sensor 400 that can measure the posture angle. The arm 4 is equipped with a posture sensor 401 that can measure the posture angle. The bucket 6 is equipped with a posture sensor 402 that can measure the posture angle. The upper swing structure 103 is equipped with a posture sensor 403 that can measure the swing angle and the posture of the upper swing structure. The posture angle of the upper swing structure 103 in a case of the hydraulic excavator 100 being stopped on a slope can also be measured by the posture sensor 403.

As illustrated in FIG. 2, a hydraulic drive system 107 includes four closed-circuit pumps connected in a closed circuit and four open-circuit pumps connected in an open circuit with respect to three kinds of single-rod hydraulic cylinders and three kinds of hydraulic motors. When driving the single-rod hydraulic cylinder, the hydraulic drive system 107 executes flow rate control by combining one closed-circuit pump and one open-circuit pump. Furthermore, selector valves are disposed for each of these respective hydraulic pumps, and a configuration in which a plurality of closed-circuit pumps and a plurality of open-circuit pumps can join for one single-rod hydraulic cylinder is made. Moreover, at the time of joining for one single-rod hydraulic cylinder, the selector valves are controlled by a controller in such a manner that one closed-circuit pump and one open-circuit pump are combined to join.

The hydraulic drive system 107 is a drive system for driving the hydraulic excavator 100 and is mounted in the upper swing structure 103. The hydraulic drive system 107 is used for driving of the swing motor 7 and the travelling motors 8a and 8b in addition to the boom cylinder 1, the arm cylinder 3, and the bucket cylinder 5 forming the front work implement 106. The swing motor 7 and the travelling motors 8a and 8b are hydraulic motors that receive supply of the hydraulic operating fluid and are rotationally driven.

Furthermore, the hydraulic drive system 107 drives the boom cylinder 1, the arm cylinder 3, the bucket cylinder 5, the swing motor 7, and the travelling motors 8a and 8b, which are hydraulic actuators, according to operation of an operation device 56 installed in a cab 101. Here, an instruction regarding extension/contraction action, that is, the action direction and the action speed, of the boom cylinder 1, the arm cylinder 3, and the bucket cylinder 5 is made on the basis of the operation direction and the operation amount of the respective levers 56a to 56d of the operation device 56.

Moreover, the hydraulic drive system 107 includes an engine 9 that is a power source. The engine 9 is formed of, for example, predetermined gears and is connected to a power transmission device 10 for distributing power. Hydraulic pumps 12, 13, . . . , 19 that are variable flow rate hydraulic pumps and a charge pump 11 that replenishes a flow line 229 to be described later with the hydraulic fluid are each connected to the power transmission device 10.

Moreover, the hydraulic pumps 12, 14, 16, and 18 are closed-circuit pumps of the variable displacement type including a bidirectionally tiltable swash plate mechanism (not illustrated) having input/output ports as two, that is, a pair of flow-out/in ports, that allow the hydraulic operating fluid to flow out/in in both directions, and a regulator 12a, 14a, 16a, or 18a that regulates the tilting angle (inclination angle) of a swash plate of the bidirectionally tiltable type forming this bidirectionally tiltable swash plate mechanism. The regulators 12a, 14a, 16a, and 18a regulate the tilting angle of the swash plate of the corresponding closed-circuit pump 12, 14, 16, or 18 and control the flow rate of the hydraulic operating fluid delivered from the closed-circuit pump 12, 14, 16, or 18 in response to an operation signal output from a controller 57. Furthermore, the closed-circuit pumps 12, 14, 16, and 18 function as a hydraulic motor when receiving supply of the hydraulic operating fluid.

Moreover, the hydraulic pumps 13, 15, 17, and 19 are open-circuit pumps of the variable displacement type including a unidirectionally tiltable swash plate mechanism (not illustrated) having a flow-out port that allows the hydraulic operating fluid to flow out/in in a single direction and a regulator 13a, 15a, 17a, or 19a that regulates the tilting angle (inclination angle) of a swash plate of the unidirectionally tiltable type forming this unidirectionally tiltable swash plate mechanism. The regulators 13a, 15a, 17a, and 19a regulate the tilting angle of the swash plate of the corresponding open-circuit pump 13, 15, 17, or 19 and control the flow rate of the hydraulic operating fluid delivered from the open-circuit pump 13, 15, 17, or 19 in response to the operation signal output from the controller 57.

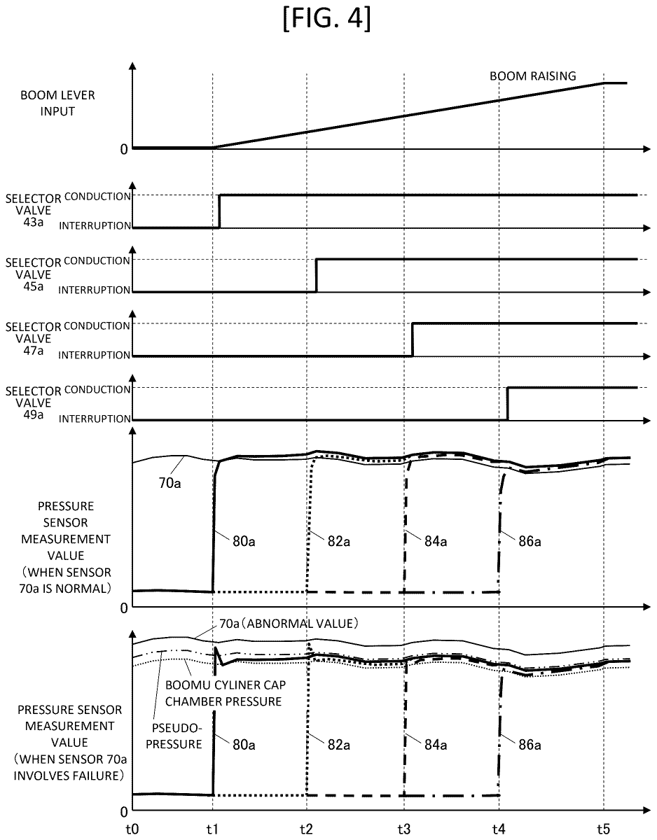

Furthermore, the tilting swash plate mechanisms of the hydraulic pumps 12, 13, . . . , 19 include means (not illustrated) that senses the tilting angle and can use the means when the delivery flow rate is used for a trigger as the switching timing of the selector valve in a time chart illustrated in FIG. 4 to be described later. Alternatively, the tilting swash plate mechanisms may include means that measures the control pressure of the regulator of the hydraulic pump 12, 13, . . . , 19, and regarding each pump, the tilting state of the swash plate and the delivery flow rate may be calculated from the control pressure of the regulator.

Moreover, the closed-circuit pumps 12, 14, 16, and 18 have a structure that can generate a driving force by the regulator for both of the direction in which the tilting angle is set to the maximum angle and the direction in which the tilting angle is set to the minimum angle because the tilting angle of the swash plate is controlled in two directions. In contrast, with the open-circuit pumps 13, 15, 17, and 19, because the tilting angle of the swash plate is controlled in one direction, the driving force by the regulator acts only in the direction in which the tilting angle is set to the maximum angle, and a return to the minimum angle depends on a restoring force by a spring. Thus, the responsiveness when the tilting angle is controlled in such a direction as to decrease the delivery amount is higher in the closed-circuit pumps 12, 14, 16, and 18.

Specifically, a flow line 200 is connected to one input/output port of the first closed-circuit pump 12, and a flow line 201 is connected to the other input/output port. Multiple, for example, four, selector valves 43a, 43b, 43c, and 43d are connected to the flow lines 200 and 201. The selector valves 43a, 43b, and 43c are closed-circuit selector valves for switching supply of the hydraulic operating fluid supplied to the boom cylinder 1, the arm cylinder 3, and the bucket cylinder 5 connected to the first closed-circuit pump 12 in a closed circuit manner. Furthermore, the selector valve 43d is a closed-circuit selector valve for the hydraulic motor for switching supply of the hydraulic operating fluid supplied to the swing motor 7 connected to the first closed-circuit pump 12 in a closed circuit manner. In addition, the selector valves 43a, 43b, 43c, and 43d are configured to execute switching between conduction and interruption of the flow lines 200 and 201 in response to the operation signal output from the controller 57, and are set to the interrupting state when the output of the operation signal from the controller 57 does not exist. The controller 57 executes control to keep the selector valves 43a, 43b, 43c, and 43d from simultaneously becoming the conductive state.

Moreover, the selector valve 43a is connected to the boom cylinder 1 through flow lines 212 and 213. Thus, the first closed-circuit pump 12 forms a closed circuit A in which the first closed-circuit pump 12 is connected to the boom cylinder 1 through the flow lines 200 and 201, the selector valve 43a, and the flow lines 212 and 213 in a closed circuit manner when the selector valve 43a has become the conductive state in response to the operation signal output from the controller 57.

Furthermore, the selector valve 43b is connected to the arm cylinder 3 through flow lines 214 and 215. Thus, the first closed-circuit pump 12 forms a closed circuit B in which the first closed-circuit pump 12 is connected to the arm cylinder 3 through the flow lines 200 and 201, the selector valve 43b, and the flow lines 214 and 215 in a closed circuit manner when the selector valve 43b has become the conductive state in response to the operation signal output from the controller 57.

Moreover, the selector valve 43c is connected to the bucket cylinder 5 through flow lines 216 and 217. Thus, the first closed-circuit pump 12 forms a closed circuit C in which the first closed-circuit pump 12 is connected to the bucket cylinder 5 through the flow lines 200 and 201, the selector valve 43c, and the flow lines 216 and 217 in a closed circuit manner when the selector valve 43c has become the conductive state due to the operation signal from the controller 57.

Furthermore, the selector valve 43d is connected to the swing motor 7 through flow lines 218 and 219. Thus, the first closed-circuit pump 12 forms a closed circuit D in which the first closed-circuit pump 12 is connected to the swing motor 7 through the flow lines 200 and 201, the selector valve 43d, and the flow lines 218 and 219 in a closed circuit manner when the selector valve 43d has become the conductive state due to the operation signal from the controller 57.

Here, the flow line 212 is also a connection flow line for the hydraulic cylinder for independently connecting the boom cylinder 1 to a plurality of selector valves 44a, 46a, 48a, and 50a of open circuits E, F, G, and H to be described later. Furthermore, the flow line 214 is also a connection flow line for the hydraulic cylinder for independently connecting the arm cylinder 3 to a plurality of selector valves 44b, 46b, 48b, and 50b of the open circuits E, F, G, and H to be described later. Moreover, the flow line 216 is also a connection flow line for the hydraulic cylinder for independently connecting the bucket cylinder 5 to a plurality of selector valves 44c, 46c, 48c, and 50c of the open circuits E, F, G, and H to be described later.

Furthermore, a flow line 203 is connected to one input/output port of the second closed-circuit pump 14, and a flow line 204 is connected to the other input/output port of the second closed-circuit pump 14. Multiple, for example, four, selector valves 45a, 45b, 45c, and 45d are connected to the flow lines 203 and 204. The selector valves 45a, 45b, and 45c are closed-circuit selector valves for switching supply of the hydraulic operating fluid supplied to the boom cylinder 1, the arm cylinder 3, and the bucket cylinder 5 connected to the second closed-circuit pump 14 in a closed circuit manner. Furthermore, the selector valve 45d is a closed-circuit selector valve for the hydraulic motor for switching supply of the hydraulic operating fluid supplied to the swing motor 7 connected to the second closed-circuit pump 14 in a closed circuit manner. In addition, the selector valves 45a, 45b, 45c, and 45d are configured to execute switching between conduction and interruption of the flow lines 203 and 204 in response to the operation signal output from the controller 57, and become the interrupting state when the output of the operation signal from the controller 57 does not exist. The controller 57 executes control to keep the selector valves 45a, 45b, 45c, and 45d from simultaneously becoming the conductive state.

Moreover, the selector valve 45a is connected to the boom cylinder 1 through the flow lines 212 and 213. Thus, the second closed-circuit pump 14 forms the closed circuit A in which the second closed-circuit pump 14 is connected to the boom cylinder 1 through the flow lines 203 and 204, the selector valve 45a, and the flow lines 212 and 213 in a closed circuit manner when the selector valve 45a has become the conductive state due to the operation signal from the controller 57. Furthermore, the selector valve 45b is connected to the arm cylinder 3 through the flow lines 214 and 215. Thus, the second closed-circuit pump 14 forms the closed circuit B in which the second closed-circuit pump 14 is connected to the arm cylinder 3 through the flow lines 203 and 204, the selector valve 45b, and the flow lines 214 and 215 in a closed circuit manner when the selector valve 45b has become the conductive state due to the operation signal from the controller 57.

Moreover, the selector valve 45c is connected to the bucket cylinder 5 through the flow lines 216 and 217. Thus, the second closed-circuit pump 14 forms the closed circuit C in which the second closed-circuit pump 14 is connected to the bucket cylinder 5 through the flow lines 203 and 204, the selector valve 45c, and the flow lines 216 and 217 in a closed circuit manner when the selector valve 45c has become the conductive state due to the operation signal from the controller 57. Furthermore, the selector valve 45d is connected to the swing motor 7 through the flow lines 218 and 219. Thus, the second closed-circuit pump 14 forms the closed circuit D in which the second closed-circuit pump 14 is connected to the swing motor 7 through the flow lines 203 and 204, the selector valve 45d, and the flow lines 218 and 219 in a closed circuit manner when the selector valve 45d has become the conductive state due to the operation signal from the controller 57.

Next, a flow line 206 is connected to one input/output port of the third closed-circuit pump 16, and a flow line 207 is connected to the other input/output port of the third closed-circuit pump 16. Multiple, for example, four, selector valves 47a, 47b, 47c, and 47d are connected to the flow lines 206 and 207. The selector valves 47a, 47b, and 47c are closed-circuit selector valves for switching supply of the hydraulic operating fluid supplied to the boom cylinder 1, the arm cylinder 3, and the bucket cylinder 5 connected to the third closed-circuit pump 16 in a closed circuit manner. Furthermore, the selector valve 47d is a closed-circuit selector valve for the hydraulic motor for switching supply of the hydraulic operating fluid supplied to the swing motor 7 connected to the third closed-circuit pump 16 in a closed circuit manner. In addition, the selector valves 47a, 47b, 47c, and 47d are configured to execute switching between conduction and interruption of the flow lines in response to the operation signal output from the controller 57, and become the interrupting state when the output of the operation signal from the controller 57 does not exist. The controller 57 executes control to keep the selector valves 47a, 47b, 47c, and 47d from simultaneously becoming the conductive state.

Moreover, the selector valve 47a is connected to the boom cylinder 1 through the flow lines 212 and 213. Thus, the third closed-circuit pump 16 forms the closed circuit A in which the third closed-circuit pump 16 is connected to the boom cylinder 1 through the flow lines 206 and 207, the selector valve 47a, and the flow lines 212 and 213 in a closed circuit manner when the selector valve 47a has become the conductive state due to the operation signal from the controller 57. Furthermore, the selector valve 47b is connected to the arm cylinder 3 through the flow lines 214 and 215. Thus, the third closed-circuit pump 16 forms the closed circuit B in which the third closed-circuit pump 16 is connected to the arm cylinder 3 through the flow lines 206 and 207, the selector valve 47b, and the flow lines 214 and 215 in a closed circuit manner when the selector valve 47b has become the conductive state due to the operation signal from the controller 57.

Moreover, the selector valve 47c is connected to the bucket cylinder 5 through the flow lines 216 and 217. Thus, the third closed-circuit pump 16 forms the closed circuit C in which the third closed-circuit pump 16 is connected to the bucket cylinder 5 through the flow lines 206 and 207, the selector valve 47c, and the flow lines 216 and 217 in a closed circuit manner when the selector valve 47c has become the conductive state due to the operation signal from the controller 57. Furthermore, the selector valve 47d is connected to the swing motor 7 through the flow lines 218 and 219. Thus, the third closed-circuit pump 16 forms the closed circuit D in which the third closed-circuit pump 16 is connected to the swing motor 7 through the flow lines 206 and 207, the selector valve 47d, and the flow lines 218 and 219 in a closed circuit manner when the selector valve 47d has become the conductive state due to the operation signal from the controller 57.

Next, a flow line 209 is connected to one input/output port of the fourth closed-circuit pump 18, and a flow line 210 is connected to the other input/output port of the fourth closed-circuit pump 18. Multiple, for example, four, selector valves 49a, 49b, 49c, and 49d are connected to the flow lines 209 and 210. The selector valves 49a, 49b, and 49c are closed-circuit selector valves for switching supply of the hydraulic operating fluid supplied to the boom cylinder 1, the arm cylinder 3, and the bucket cylinder 5 connected to the fourth closed-circuit pump 18 in a closed circuit manner. Furthermore, the selector valve 49d is a closed-circuit selector valve for the hydraulic motor for switching supply of the hydraulic operating fluid supplied to the swing motor 7 connected to the fourth closed-circuit pump 18 in a closed circuit manner. In addition, the selector valves 49a, 49b, 49c, and 49d are configured to execute switching between conduction and interruption of the flow lines in response to the operation signal output from the controller 57, and are set to the interrupting state when the output of the operation signal from the controller 57 does not exist. The controller 57 executes control to keep the selector valves 49a, 49b, 49c, and 49d from simultaneously becoming the conductive state.

Moreover, the selector valve 49a is connected to the boom cylinder 1 through the flow lines 212 and 213. Thus, the fourth closed-circuit pump 18 forms the closed circuit A in which the fourth closed-circuit pump 18 is connected to the boom cylinder 1 through the flow lines 209 and 210, the selector valve 49a, and the flow lines 212 and 213 in a closed circuit manner when the selector valve 49a has become the conductive state due to the operation signal from the controller 57. Furthermore, the selector valve 49b is connected to the arm cylinder 3 through the flow lines 214 and 215. Thus, the fourth closed-circuit pump 18 forms the closed circuit B in which the fourth closed-circuit pump 18 is connected to the arm cylinder 3 through the flow lines 209 and 210, the selector valve 49b, and the flow lines 214 and 215 in a closed circuit manner when the selector valve 49b has become the conductive state due to the operation signal from the controller 57.

Moreover, the selector valve 49c is connected to the bucket cylinder 5 through the flow lines 216 and 217. Thus, the fourth closed-circuit pump 18 forms the closed circuit C in which the fourth closed-circuit pump 18 is connected to the bucket cylinder 5 through the flow lines 209 and 210, the selector valve 49c, and the flow lines 216 and 217 in a closed circuit manner when the selector valve 49c has become the conductive state due to the operation signal from the controller 57. Furthermore, the selector valve 49d is connected to the swing motor 7 through the flow lines 218 and 219. Thus, the fourth closed-circuit pump 18 forms the closed circuit D in which the fourth closed-circuit pump 18 is connected to the swing motor 7 through the flow lines 209 and 210, the selector valve 49d, and the flow lines 218 and 219 in a closed circuit manner when the selector valve 49d has become the conductive state due to the operation signal from the controller 57.

Moreover, multiple, for example, four, selector valves 44a, 44b, 44c, and 44d and a relief valve 21 are connected to one input/output port of the first open-circuit pump 13 through a flow line 202. The other input/output port of the first open-circuit pump 13 is connected to a hydraulic operating fluid tank 25 to form the open circuit E. The selector valves 44a, 44b, 44c, and 44d are open-circuit selector valves that execute switching between conduction and interruption of the flow line 202 in response to the operation signal output from the controller 57 and switch the supply destination of the hydraulic operating fluid caused to flow out from the first open-circuit pump 13 to a coupling flow line 301, 302, 303, or 304 to be described later. The selector valves 44a, 44b, 44c, and 44d are set to the interrupting state when the output of the operation signal from the controller 57 does not exist. The controller 57 executes control to keep the selector valves 44a, 44b, 44c, and 44d from simultaneously becoming the conductive state.

Furthermore, the selector valve 44a is connected to the boom cylinder 1 through the coupling flow line 301 and the flow line 212. The coupling flow line 301 is a coupling line disposed to branch from the flow line 212. Moreover, the selector valve 44b is connected to the arm cylinder 3 through the coupling flow line 302 and the flow line 214. The coupling flow line 302 is a coupling line disposed to branch from the flow line 214. Furthermore, the selector valve 44c is connected to the bucket cylinder 5 through the coupling flow line 303 and the flow line 216. The coupling flow line 303 is a coupling line disposed to branch from the flow line 216. Moreover, the selector valve 44d is connected to proportional selector valves 54 and 55 that are control valves to control feed and discharge of the hydraulic operating fluid to the travelling motors 8a and 8b through the coupling flow line 304 and a flow line 220. Meanwhile, when the hydraulic operating fluid pressure in the flow line 202 has become equal to or higher than a predetermined pressure, the relief valve 21 causes the hydraulic operating fluid in the flow line 202 to escape to the hydraulic operating fluid tank 25 and protects the flow line 202 and hence the hydraulic drive system 107 (hydraulic circuit).

Furthermore, a proportional valve 64 as a pressure compensated flow control valve is connected between the flow line 202 and the hydraulic operating fluid tank 25. The proportional valve 64 is disposed on a branch flow line 202a as a line that is made to branch from the flow line 202, which is the line that couples the selector valves 44a, 44b, 44c, and 44d with the first open-circuit pump 13, and leads to the hydraulic operating fluid tank 25. Thus, the proportional valve 64 controls the flow rate of the hydraulic operating fluid caused to flow from the flow line 202 to the hydraulic operating fluid tank 25 in response to the operation signal output from the controller 57. In addition, the proportional valve 64 is set to the interrupting state when the output of the operation signal from the controller 57 does not exist.

Moreover, multiple, for example, four, selector valves 46a, 46b, 46c, and 46d and a relief valve 22 are connected to one input/output port of the second open-circuit pump 15 through a flow line 205. The other input/output port of the second open-circuit pump 15 is connected to the hydraulic operating fluid tank 25 to form the open circuit F. The selector valves 46a, 46b, 46c, and 46d are open-circuit selector valves that execute switching between conduction and interruption of the flow line 205 in response to the operation signal output from the controller 57 and switch the supply destination of the hydraulic operating fluid caused to flow out from the second open-circuit pump 15 to the coupling flow line 301, 302, 303, or 304. The selector valves 46a, 46b, 46c, and 46d are set to the interrupting state when the output of the operation signal from the controller 57 does not exist. The controller 57 executes control to keep the selector valves 46a, 46b, 46c, and 46d from simultaneously becoming the conductive state.

Furthermore, the selector valve 46a is connected to the boom cylinder 1 through the coupling flow line 301 and the flow line 212. The selector valve 46b is connected to the arm cylinder 3 through the coupling flow line 302 and the flow line 214. Moreover, the selector valve 46c is connected to the bucket cylinder 5 through the coupling flow line 303 and the flow line 216. The selector valve 46d is connected to the proportional selector valves 54 and 55 through the coupling flow line 304 and the flow line 220. Meanwhile, when the hydraulic operating fluid pressure in the flow line 205 has become equal to or higher than a predetermined pressure, the relief valve 22 causes the hydraulic operating fluid in the flow line 205 to escape to the hydraulic operating fluid tank 25 and protects the flow line 205.

Furthermore, a proportional valve 65 as a pressure compensated flow control valve is connected between the flow line 205 and the hydraulic operating fluid tank 25. The proportional valve 65 is disposed on a branch flow line 205a as a line that is made to branch from the flow line 205, which is the line that couples the selector valves 46a, 46b, 46c, and 46d with the second open-circuit pump 15, and leads to the hydraulic operating fluid tank 25. Thus, the proportional valve 65 controls the flow rate of the hydraulic operating fluid caused to flow from the flow line 205 to the hydraulic operating fluid tank 25 in response to the operation signal output from the controller 57. In addition, the proportional valve 65 is set to the interrupting state when the output of the operation signal from the controller 57 does not exist.

Moreover, multiple, for example, four, selector valves 48a, 48b, 48c, and 48d and a relief valve 23 are connected to one input/output port of the third open-circuit pump 17 through a flow line 208. The other input/output port of the third open-circuit pump 17 is connected to the hydraulic operating fluid tank 25 to form the open circuit G. The selector valves 48a, 48b, 48c, and 48d are open-circuit selector valves that execute switching between conduction and interruption of the flow line 208 in response to the operation signal output from the controller 57 and switch the supply destination of the hydraulic operating fluid caused to flow out from the third open-circuit pump 17 to the coupling flow line 301, 302, 303, or 304. The selector valves 48a, 48b, 48c, and 48d are set to the interrupting state when the output of the operation signal from the controller 57 does not exist. The controller 57 executes control to keep the selector valves 48a, 48b, 48c, and 48d from simultaneously becoming the conductive state.

Furthermore, the selector valve 48a is connected to the boom cylinder 1 through the coupling flow line 301 and the flow line 212. The selector valve 48b is connected to the arm cylinder 3 through the coupling flow line 302 and the flow line 214. Moreover, the selector valve 48c is connected to the bucket cylinder 5 through the coupling flow line 303 and the flow line 216. The selector valve 48d is connected to the proportional selector valves 54 and 55 through the coupling flow line 304 and the flow line 220. Meanwhile, when the hydraulic operating fluid pressure in the flow line 208 has become equal to or higher than a predetermined pressure, the relief valve 23 causes the hydraulic operating fluid in the flow line 208 to escape to the hydraulic operating fluid tank 25 and protects the flow line 208.

Furthermore, a proportional valve 66 as a pressure compensated flow control valve is connected between the flow line 208 and the hydraulic operating fluid tank 25. The proportional valve 66 is disposed on a branch flow line 208a as a line that is made to branch from the flow line 208, which is the line that couples the selector valves 48a, 48b, 48c, and 48d with the third open-circuit pump 17, and leads to the hydraulic operating fluid tank 25. Thus, the proportional valve 66 controls the flow rate of the hydraulic operating fluid caused to flow from the flow line 208 to the hydraulic operating fluid tank 25 in accordance with the operation signal output from the controller 57. In addition, the proportional valve 66 is set to the interrupting state when the output of the operation signal from the controller 57 does not exist.

Moreover, multiple, for example, four, selector valves 50a, 50b, 50c, and 50d and a relief valve 24 are connected to one input/output port of the fourth open-circuit pump 19 through a flow line 211. The other input/output port of the fourth open-circuit pump 19 is connected to the hydraulic operating fluid tank 25 to form the open circuit H. The selector valves 50a, 50b, 50c, and 50d are open-circuit selector valves that execute switching between conduction and interruption of the flow line 211 in response to the operation signal output from the controller 57 and switch the supply destination of the hydraulic operating fluid caused to flow out from the fourth open-circuit pump 19 to the coupling flow line 301, 302, 303, or 304. The selector valves 50a, 50b, 50c, and 50d are set to the interrupting state when the output of the operation signal from the controller 57 does not exist. The controller 57 executes control to keep the selector valves 50a, 50b, 50c, and 50d from simultaneously becoming the conductive state.

Furthermore, the selector valve 50a is connected to the boom cylinder 1 through the coupling flow line 301 and the flow line 212. The selector valve 50b is connected to the arm cylinder 3 through the coupling flow line 302 and the flow line 214. Moreover, the selector valve 50c is connected to the bucket cylinder 5 through the coupling flow line 303 and the flow line 216. The selector valve 50d is connected to the proportional selector valves 54 and 55 through the coupling flow line 304 and the flow line 220. Meanwhile, when the hydraulic operating fluid pressure in the flow line 211 has become equal to or higher than a predetermined pressure, the relief valve 24 causes the hydraulic operating fluid in the flow line 211 to escape to the hydraulic operating fluid tank 25 and protects the flow line 211.

Furthermore, a pressure compensated proportional valve 67 is connected between the flow line 211 and the hydraulic operating fluid tank 25. The proportional valve 67 is disposed on a branch flow line 211a as a line that is made to branch from the flow line 211, which is the line that couples the selector valves 50a, 50b, 50c, and 50d with the fourth open-circuit pump 19, and leads to the hydraulic operating fluid tank 25. Thus, the proportional valve 67 controls the flow rate of the hydraulic operating fluid caused to flow from the flow line 211 to the hydraulic operating fluid tank 25 in response to the operation signal output from the controller 57. In addition, the proportional valve 67 is set to the interrupting state when the output of the operation signal from the controller 57 does not exist.

Here, the coupling flow line 301 is composed of connection flow lines 305a, 306a, 307a, and 308a for the open circuit connected to the delivery side, which is the side to which the hydraulic operating fluid of at least one selector valve 44a, 46a, 48a, or 50a in the plurality of open circuits E, F, G, and H is caused to flow out, and a connection flow line 309a for the closed circuit connected to the flow line 212 forming the closed circuit A. The coupling flow line 302 is composed of connection flow lines 305b, 306b, 307b, and 308b for the open circuit connected to the delivery side, which is the side to which the hydraulic operating fluid of at least one selector valve 44b, 46b, 48b, or 50b in the plurality of open circuits E, F, G, and H is caused to flow out, and a connection flow line 309b for the closed circuit connected to the flow line 214 forming the closed circuit B. The coupling flow line 303 is composed of connection flow lines 305c, 306c, 307c, and 308c for the open circuit connected to the delivery side, which is the side to which the hydraulic operating fluid of at least one selector valve 44c, 46c, 48c, or 50c in the plurality of open circuits E, F, G, and H is caused to flow out, and a connection flow line 309c for the closed circuit connected to the flow line 216 forming the closed circuit C. Moreover, the coupling flow line 304 is composed of connection flow lines 305d, 306d, 307d, and 308d for the open circuit connected to the delivery side, which is the side to which the hydraulic operating fluid of at least one selector valve 44d, 46d, 48d, or 50d in the plurality of open circuits E, F, G, and H is caused to flow out, and a connection flow line 309d connected to the flow line 220.

The hydraulic drive system 107 is formed of the closed circuits A, B, C, and D in which the closed-circuit pumps 12, 14, 16, and 18 and the boom cylinder 1, the arm cylinder 3, the bucket cylinder 5, and the swing motor 7 are connected in a closed circuit manner from one input/output port of the hydraulic pump to the other input/output port of the hydraulic pump through the actuator. Moreover, the hydraulic drive system 107 is formed of the open circuits E, F, G, and H in which the open-circuit pumps 13, 15, 17, and 19 and the selector valves 44a, 44b, 44c, 44d, 46a, 46b, 46c, 46d, 48a, 48b, 48c, 48d, 50a, 50b, 50c, and 50d are connected in such a manner that the selector valve is connected to one input/output port of the hydraulic pump and the hydraulic operating fluid tank 25 is connected to the other input/output port of the hydraulic pump. In addition, the closed circuits A, B, C, and D and the open circuits E, F, G, and H are each disposed as, for example, four circuits and are disposed to make pairs.

Meanwhile, the delivery port of a charge pump 11 is connected to a charge relief valve 20 and charge check valves 26, 27, 28, 29, 40a, 40b, 41a, 41b, 42a, and 42b through the flow line 229. The suction port of the charge pump 11 is connected to the hydraulic operating fluid tank 25. Here, the charge relief valve 20 regulates the charge pressure of the charge check valves 26, 27, 28, 29, 40a, 40b, 41a, 41b, 42a, and 42b.

Furthermore, the charge check valve 26 supplies the hydraulic operating fluid from the charge pump 11 to the flow lines 200 and 201 when the hydraulic operating fluid pressure in the flow lines 200 and 201 is lower than a pressure set by the charge relief valve 20. Similarly, the charge check valve 27 supplies the hydraulic operating fluid from the charge pump 11 to the flow lines 203 and 204 when the hydraulic operating fluid pressure in the flow lines 203 and 204 is lower than a pressure set by the charge relief valve 20. Moreover, the charge check valve 28 supplies the hydraulic operating fluid from the charge pump 11 to the flow lines 206 and 207 when the hydraulic operating fluid pressure in the flow lines 206 and 207 is lower than a pressure set by the charge relief valve 20. Similarly, the charge check valve 29 supplies the hydraulic operating fluid from the charge pump 11 to the flow lines 209 and 210 when the hydraulic operating fluid pressure in the flow lines 209 and 210 is lower than a pressure set by the charge relief valve 20.

Moreover, the charge check valves 40a and 40b supply the hydraulic operating fluid from the charge pump 11 to the flow lines 212 and 213 when the hydraulic operating fluid pressure in the flow lines 212 and 213 is lower than a pressure set by the charge relief valve 20. Similarly, the charge check valves 41a and 41b supply the hydraulic operating fluid from the charge pump 11 to the flow lines 214 and 215 when the hydraulic operating fluid pressure in the flow lines 214 and 215 is lower than a pressure set by the charge relief valve 20. Furthermore, the charge check valves 42a and 42b supply the hydraulic operating fluid from the charge pump 11 to the flow lines 216 and 217 when the hydraulic operating fluid pressure in the flow lines 216 and 217 is lower than a pressure set by the charge relief valve 20.

In addition, a pair of relief valves 30a and 30b are connected between the flow lines 200 and 201. When the hydraulic operating fluid pressure in the flow lines 200 and 201 has become equal to or higher than a predetermined pressure, the relief valves 30a and 30b cause the hydraulic operating fluid in the flow lines 200 and 201 to escape to the hydraulic operating fluid tank 25 through the charge relief valve 20 and protect the flow lines 200 and 201. Similarly, a pair of relief valves 31a and 31b are connected between the flow lines 203 and 204. When the hydraulic operating fluid pressure in the flow lines 203 and 204 has become equal to or higher than a predetermined pressure, the relief valves 31a and 31b cause the hydraulic operating fluid in the flow lines 203 and 204 to escape to the hydraulic operating fluid tank 25 through the charge relief valve 20 and protect the flow lines 203 and 204.

Moreover, relief valves 32a and 32b are also connected between the flow lines 206 and 207. When the hydraulic operating fluid pressure in the flow lines 206 and 207 has become equal to or higher than a predetermined pressure, the relief valves 32a and 32b cause the hydraulic operating fluid in the flow lines 206 and 207 to escape to the hydraulic operating fluid tank 25 through the charge relief valve 20 and protect the flow lines 206 and 207. Furthermore, relief valves 33a and 33b are also connected between the flow lines 209 and 210. When the hydraulic operating fluid pressure in the flow lines 209 and 210 has become equal to or higher than a predetermined pressure, the relief valves 33a and 33b cause the hydraulic operating fluid in the flow lines 209 and 210 to escape to the hydraulic operating fluid tank 25 through the charge relief valve 20 and protect the flow lines 209 and 210.

Next, the flow line 212 is connected to the cap chamber 1a of the boom cylinder 1. The flow line 213 is connected to the rod chamber 1b of the boom cylinder 1. In addition, relief valves 37a and 37b are connected between the flow lines 212 and 213. When the hydraulic operating fluid pressure in the flow lines 212 and 213 has become equal to or higher than a predetermined pressure, the relief valves 37a and 37b cause the hydraulic operating fluid in the flow lines 212 and 213 to escape to the hydraulic operating fluid tank 25 through the charge relief valve 20 and protect the flow lines 212 and 213. Moreover, a flushing valve 34 is connected between the flow lines 212 and 213. The flushing valve 34 discharges the hydraulic operating fluid as a surplus (surplus fluid) in the flow lines 212 and 213 to the hydraulic operating fluid tank 25 through the charge relief valve 20.

Furthermore, the flow line 214 is connected to the cap chamber 3a of the arm cylinder 3. The flow line 215 is connected to the rod chamber 3b of the arm cylinder 3. Moreover, relief valves 38a and 38b are connected between the flow lines 214 and 215. When the hydraulic operating fluid pressure in the flow lines 214 and 215 has become equal to or higher than a predetermined pressure, the relief valves 38a and 38b cause the hydraulic operating fluid in the flow lines 214 and 215 to escape to the hydraulic operating fluid tank 25 through the charge relief valve 20 and protect the flow lines 214 and 215. Furthermore, a flushing valve 35 is connected between the flow lines 214 and 215. The flushing valve 35 discharges the hydraulic operating fluid as a surplus in the flow lines 214 and 215 to the hydraulic operating fluid tank 25 through the charge relief valve 20.

Furthermore, the flow line 216 is connected to the cap chamber 5a of the bucket cylinder 5. The flow line 217 is connected to the rod chamber 5b of the bucket cylinder 5. Moreover, relief valves 39a and 39b are connected between the flow lines 216 and 217. When the hydraulic operating fluid pressure in the flow lines 216 and 217 has become equal to or higher than a predetermined pressure, the relief valves 39a and 39b cause the hydraulic operating fluid in the flow lines 216 and 217 to escape to the hydraulic operating fluid tank 25 through the charge relief valve 20 and protect the flow lines 216 and 217. Furthermore, a flushing valve 36 is connected between the flow lines 216 and 217. The flushing valve 36 discharges the hydraulic operating fluid as a surplus in the flow lines 216 and 217 to the hydraulic operating fluid tank 25 through the charge relief valve 20.

Moreover, the flow lines 218 and 219 are each connected to the swing motor 7. Furthermore, relief valves 51a and 51b are connected between the flow lines 218 and 219. When the pressure difference of the hydraulic operating fluid (flow line pressure difference) between the flow lines 218 and 219 has become equal to or higher than a predetermined pressure, the relief valves 51a and 51b cause the hydraulic operating fluid in the flow line 218 219 on the higher pressure side to escape to the flow line 219 or 218 on the lower pressure side and protect the flow lines 218 and 219.

Moreover, the proportional selector valve 54 and the travelling motor 8a are connected by flow lines 221 and 222. Relief valves 52a and 52b are connected between the flow lines 221 and 222. When the pressure difference of the hydraulic operating fluid between the flow lines 221 and 222 has become equal to or higher than a predetermined pressure, the relief valves 52a and 52b cause the hydraulic operating fluid in the flow line 221 or 222 on the higher pressure side to escape to the flow line 222 or 221 on the lower pressure side and protect the flow lines 221 and 222. The proportional selector valve 54 is configured to switch the connection destination of the flow line 220 and the hydraulic operating fluid tank 25 to either the flow line 221 or the flow line 222 in response to the operation signal output from the controller 57, and is allowed to regulate the flow rate.

Furthermore, the proportional selector valve 55 and the travelling motor 8b are connected by flow lines 223 and 224. Relief valves 53a and 53b are connected between the flow lines 223 and 224. When the pressure difference of the hydraulic operating fluid between the flow lines 223 and 224 has become equal to or higher than a predetermined pressure, the relief valves 53a and 53b cause the hydraulic operating fluid in the flow line 223 or 224 on the higher pressure side to escape to the flow line 224 or 223 on the lower pressure side and protect the flow lines 223 and 224. The proportional selector valve 55 is configured to switch the connection destination of the flow line 220 and the hydraulic operating fluid tank 25 to either the flow line 223 or the flow line 224 in response to the operation signal output from the controller 57, and is allowed to regulate the flow rate.

A pressure sensor 80a connected to the flow line 200 measures the pressure of the flow line 200 and inputs the measurement result to the controller 57. The pressure sensor 80a measures the pressure of the one input/output port of the first closed-circuit pump 12 by measuring the pressure of the flow line 200. A pressure sensor 80b connected to the flow line 201 measures the pressure of the flow line 201 and inputs the measurement result to the controller 57. The pressure sensor 80b measures the pressure of the other input/output port of the first closed-circuit pump 12 by measuring the pressure of the flow line 201. A pressure sensor 81 connected to the flow line 202 measures the pressure of the flow line 202 and inputs the measurement result to the controller 57. The pressure sensor 81 measures the pressure of the delivery port of the first open-circuit pump 13 by measuring the pressure of the flow line 202.

A pressure sensor 82a connected to the flow line 203 measures the pressure of the flow line 203 and inputs the measurement result to the controller 57. The pressure sensor 82a measures the pressure of the one input/output port of the second closed-circuit pump 14 by measuring the pressure of the flow line 203. A pressure sensor 82b connected to the flow line 204 measures the pressure of the flow line 204 and inputs the measurement result to the controller 57. The pressure sensor 82b measures the pressure of the other input/output port of the second closed-circuit pump 14 by measuring the pressure of the flow line 204. A pressure sensor 83 connected to the flow line 205 measures the pressure of the flow line 205 and inputs the measurement result to the controller 57. The pressure sensor 83 measures the pressure of the delivery port of the second open-circuit pump 15 by measuring the pressure of the flow line 205.

A pressure sensor 84a connected to the flow line 206 measures the pressure of the flow line 206 and inputs the measurement result to the controller 57. The pressure sensor 84a measures the pressure of the one input/output port of the third closed-circuit pump 16 by measuring the pressure of the flow line 206. A pressure sensor 84b connected to the flow line 207 measures the pressure of the flow line 207 and inputs the measurement result to the controller 57. The pressure sensor 84b measures the pressure of the other input/output port of the third closed-circuit pump 16 by measuring the pressure of the flow line 207. A pressure sensor 85 connected to the flow line 208 measures the pressure of the flow line 208 and inputs the measurement result to the controller 57. The pressure sensor 85 measures the pressure of the delivery port of the third open-circuit pump 17 by measuring the pressure of the flow line 208.

A pressure sensor 86a connected to the flow line 209 measures the pressure of the flow line 209 and inputs the measurement result to the controller 57. The pressure sensor 86a measures the pressure of the one input/output port of the fourth closed-circuit pump 18 by measuring the pressure of the flow line 209. A pressure sensor 86b connected to the flow line 210 measures the pressure of the flow line 210 and inputs the measurement result to the controller 57. The pressure sensor 86b measures the pressure of the other input/output port of the fourth closed-circuit pump 18 by measuring the pressure of the flow line 210. A pressure sensor 87 connected to the flow line 211 measures the pressure of the flow line 211 and inputs the measurement result to the controller 57. The pressure sensor 87 measures the pressure of the delivery port of the fourth open-circuit pump 19 by measuring the pressure of the flow line 211.

A pressure sensor 70a connected to the flow line 212 measures the pressure of the flow line 212 and inputs the measurement result to the controller 57. The pressure sensor 70a measures the pressure of the cap chamber 1a of the boom cylinder 1 by measuring the pressure of the flow line 212. A pressure sensor 70b connected to the flow line 213 measures the pressure of the flow line 213 and inputs the measurement result to the controller 57. The pressure sensor 70b measures the pressure of the rod chamber 1b of the boom cylinder 1 by measuring the pressure of the flow line 213.

A pressure sensor 71a connected to the flow line 214 measures the pressure of the flow line 214 and inputs the measurement result to the controller 57. The pressure sensor 71a measures the pressure of the cap chamber 3a of the arm cylinder 3 by measuring the pressure of the flow line 214. A pressure sensor 71b connected to the flow line 215 measures the pressure of the flow line 215 and inputs the measurement result to the controller 57. The pressure sensor 71b measures the pressure of the rod chamber 3b of the arm cylinder 3 by measuring the pressure of the flow line 215.

A pressure sensor 72a connected to the flow line 216 measures the pressure of the flow line 216 and inputs the measurement result to the controller 57. The pressure sensor 72a measures the pressure of the cap chamber 5a of the bucket cylinder 5 by measuring the pressure of the flow line 216. A pressure sensor 72b connected to the flow line 217 measures the pressure of the flow line 217 and inputs the measurement result to the controller 57. The pressure sensor 72b measures the pressure of the rod chamber 5b of the bucket cylinder 5 by measuring the pressure of the flow line 217.

A pressure sensor 73a connected to the flow line 218 measures the pressure of the flow line 218 and inputs the measurement result to the controller 57. The pressure sensor 73a measures the pressure of one input/output port of the swing motor 7 by measuring the pressure of the flow line 218. A pressure sensor 73b connected to the flow line 219 measures the pressure of the flow line 219 and inputs the measurement result to the controller 57. The pressure sensor 73b measures the pressure of the other input/output port of the swing motor 7 by measuring the pressure of the flow line 219.

The controller 57 controls the respective regulators 12a, 13a, . . . , 19a, the selector valves 43a, 44a, . . . , 50a, 43b, 44b, . . . , 50b, 43c, 44c, . . . , 50c, 43d, 44d, . . . , 50d, and the proportional selector valves 54 and 55 on the basis of command values of the extension/contraction direction and the extension/contraction speed of the boom cylinder 1, the arm cylinder 3, and the bucket cylinder 5 from the operation device 56, command values of the rotation direction and the rotation speed of the swing motor 7 and the travelling motors 8a and 8b, and various pieces of sensor information in the hydraulic drive system 107.

Specifically, for example, the controller 57 executes pressure receiving area control to control a first flow rate, which is the flow rate of the first closed-circuit pump 12 on the side of the flow line 212 connected to the cap chamber 1a and the rod chamber 1b of the boom cylinder 1, and a second flow rate, which is the flow rate of the first open-circuit pump 13 connected to the coupling flow line 301 through the selector valve 44a, in such a manner that the ratio between the first flow rate and the second flow rate becomes a predetermined value set in advance according to the pressure receiving area of the cap chamber 1a and the rod chamber 1b of the boom cylinder 1. Similarly, the controller 57 also executes the above-described pressure receiving area control for the arm cylinder 3 and the bucket cylinder 5.

Furthermore, when causing at least one of the boom cylinder 1, the arm cylinder 3, and the bucket cylinder 5 to act, the controller 57 controls the selector valves 43a to 50a, 43b to 50b, 43c to 50c, and 43d to 50d as appropriate to supply the hydraulic operating fluid delivered from the same number of open-circuit pumps 13, 15, 17, and 19 as the corresponding closed-circuit pumps 12, 14, 16 and 18 to at least one of the boom cylinder 1, the arm cylinder 3, and the bucket cylinder 5 caused to act.

Moreover, the boom lever 56a of the operation device 56 gives a command value of the extension/contraction direction and the extension/contraction speed of the boom cylinder 1 to the controller 57. The arm lever 56b gives a command value of the extension/contraction direction and the extension/contraction speed of the arm cylinder 3 to the controller 57. The bucket lever 56c gives a command value of the extension/contraction direction and the extension/contraction speed of the bucket cylinder 5 to the controller 57. Furthermore, the swing lever 56d gives a command value of the rotation direction and the rotation speed of the swing motor 7 to the controller 57. Note that the operation device 56 has a configuration also including an operation lever (not illustrated) that gives a command value of the rotation direction and the rotation speed of the travelling motors 8a and 8b to the controller 57. In addition, a display device 58 for presenting the state of the machine body to an operator is connected to the controller 57.

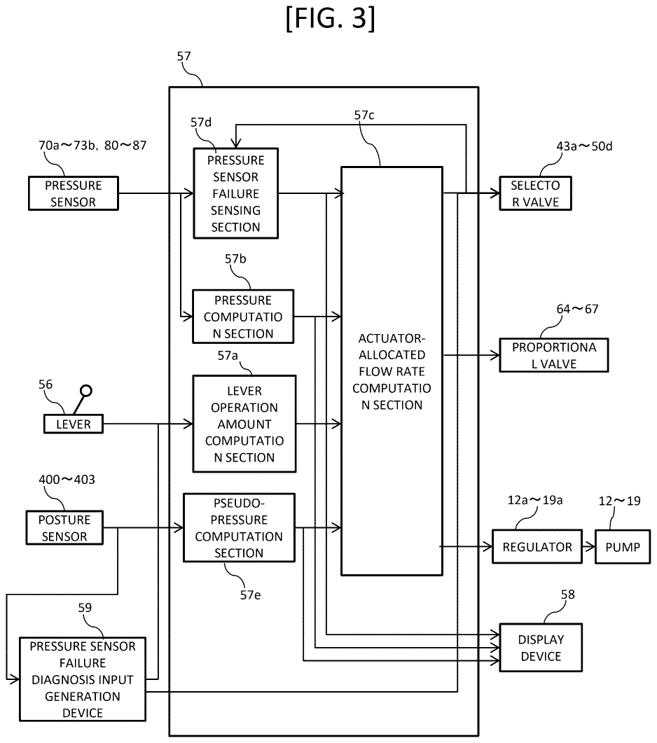

FIG. 3 is a functional block diagram of the controller 57. The controller 57 is composed of a lever operation amount computation section 57a, a pressure computation section 57b, an actuator-allocated flow rate computation section 57c, a pressure sensor failure sensing section 57d, and a pseudo-pressure computation section 57e.

The lever operation amount computation section 57a calculates the action direction and an action speed target of each actuator in response to a lever input by an operator, and inputs them to the actuator-allocated flow rate computation section 57c.

The pressure computation section 57b calculates the pressure of the respective portions from measurement values of the pressure sensors 70a to 73b and 80 to 87 disposed at the respective portions, and inputs the calculated pressure to the actuator-allocated flow rate computation section 57c and the display device 58.

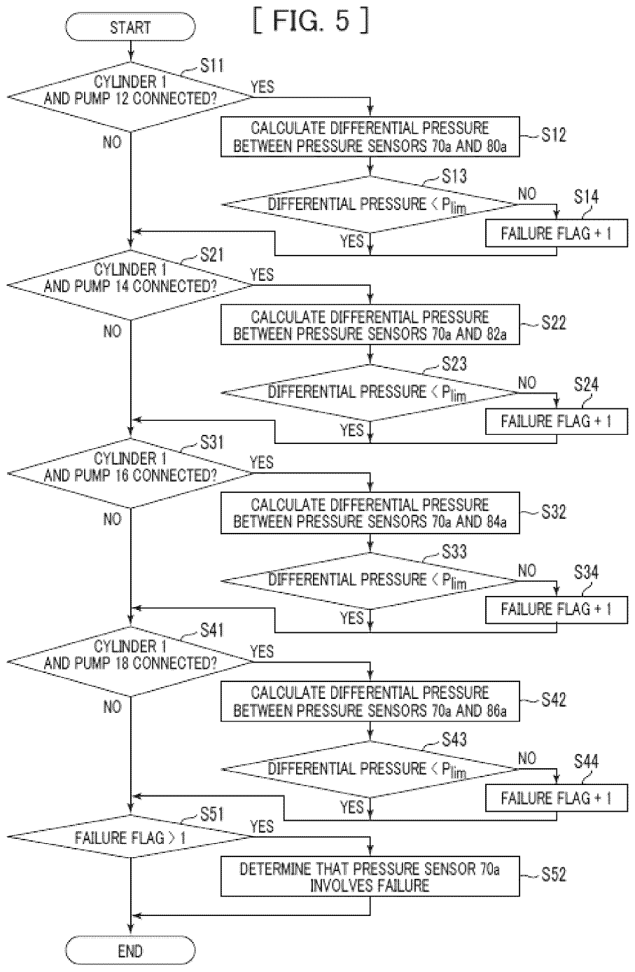

The pressure sensor failure sensing section 57d senses a failure of the pressure sensor in accordance with a flowchart illustrated in FIG. 5 from the measurement values of the pressure sensors 70a to 73b and 80 to 87 and the connection state of the pressure sensors decided from command values to the selector valves 43a to 49d, and inputs the sensing result to the actuator-allocated flow rate computation section 57c and the display device 58.

The pseudo-pressure computation section 57e calculates pseudo-pressure of the actuators 1, 3, and 5 on the basis of measurement values of the posture sensors 400 to 403, and inputs the calculated pseudo-pressure to the actuator-allocated flow rate computation section 57c and the display device 58.

In normal times, the actuator-allocated flow rate computation section 57c calculates the command values to the selector valves 43a to 50d, the proportional valves 64 to 67, and the regulators 12a to 19a on the basis of inputs from the lever operation amount computation section 57a and the pressure computation section 57b. On the other hand, when a failure of the pressure sensor has been sensed by the pressure sensor failure sensing section 57d, the actuator-allocated flow rate computation section 57c calculates the command values to the selector valves 43a to 50d, the proportional valves 64 to 67, and the regulators 12a to 19a on the basis of inputs from the pseudo-pressure computation section 57e and the lever operation amount computation section 57a.

The display device 58 displays the measurement value of each pressure sensor input from the pressure computation section 57b, the failure state of each pressure sensor input from the pressure sensor failure sensing section 57d, and the pseudo-pressure input from the pseudo-pressure computation section 57e.

A pressure sensor failure diagnosis input generation device 59 connected to the controller 57 is a device for improving the accuracy of failure sensing by the pressure sensor failure sensing section 57d. The pressure sensor failure diagnosis input generation device 59 outputs, to the lever operation amount computation section 57a, a lever operation signal for causing the hydraulic excavator 100 to take a predetermined posture suitable for diagnosis of the pressure sensor (diagnosis posture) on the basis of the measurement values of the posture sensors 400 to 403, and outputs an opening command to the selector valves 43a to 50d in the state in which the hydraulic excavator 100 stands still with the diagnosis posture. In the present embodiment, the pressure sensor failure diagnosis input generation device 59 is configured with a device independent of the controller 57. However, it may be configured as part of functions of the controller 57. Details of the pressure sensor failure diagnosis input generation device 59 will be described later.

Next, operation of the hydraulic drive system 107 illustrated in FIG. 2 will be described.

### (1) When Operation is Not Executed

In FIG. 2, when the levers 56a to 56d are not operated, the hydraulic pumps 12 to 19 are controlled to the minimum tilting angle and the selector valves 43a to 50d are all closed, and the boom cylinder 1, the arm cylinder 3, the bucket cylinder 5, and the swing motor 7 are kept at the stopped state.

### (2) In Boom Raising Operation

FIG. 4 illustrates state change of the hydraulic drive system 107 when extension action of the boom cylinder 1 is caused. FIG. 4 indicates measurement values of the pressure sensors 70a, 80a, 82a, 84a, and 86a in a case in which the pressure sensor 70a is normal and in a case in which the pressure sensor 70a involves a failure and the measurement value thereof drifts toward the positive side.

From a clock time t0 to a clock time t1, the input of the boom lever 56a is 0, and the boom cylinder 1 stands still.

From the clock time t1 to a clock time t5, a command value to extend the boom cylinder 1 is raised to the maximum value as the input of the boom lever 56a. In response to the rise in the input of the boom lever 56a, the number of connected pumps increases. The timing when the selector valve 43a, 45a, 47a, or 49a opens is the timing when the closed-circuit pump 12, 14, 16, or 18 is connected to the boom cylinder 1.

The boom lever 56a is input at the clock time t1. At this time, the selector valve 43a opens after the delivery pressure of the first closed-circuit pump 12 is raised to the pressure of the cap chamber 1a of the boom cylinder 1 before the first closed-circuit pump 12 is connected to the boom cylinder 1. The pressure raising operation is executed on the basis of values measured by the pressure sensors 70a and 80a, and the selector valve 43a is opened after the difference between the measurement value of the pressure sensor 80a and the measurement value of the pressure sensor 70a has become equal to or smaller than a threshold (first threshold).

When the pressure sensor 70a is normal, the delivery pressure of the first closed-circuit pump 12 measured by the pressure sensor 80a has been sufficiently raised, by the pressure raising processing, immediately before the opening of the selector valve 43a. When the delivery flow rate of the first closed-circuit pump 12 has increased from the clock time t1 to the clock time t2, the measurement value of the pressure sensor 80a becomes larger than the measurement value of the pressure sensor 70a by the amount of pressure loss caused when the hydraulic operating fluid passes through the line and the selector valve 43a.

When the pressure sensor 70a involves a failure and the measurement value thereof drifts toward the positive side, due to the pressure raising processing, the delivery pressure of the first closed-circuit pump 12 measured by the pressure sensor 80a becomes higher than the pressure of the cap chamber 1a of the boom cylinder 1 immediately before the opening of the selector valve 43a. Due to this, shock occurs when the selector valve 43a is opened.

Even in a period from the clock time t2 to a clock time t3, the selector valve 45a is opened after the pressure of the second closed-circuit pump 14 is raised. However, where the pressure sensor 70a involves a failure, shock occurs when each selector valve is opened due to excessive pressure raising. Because three or more pressure sensors are connected to the same line by the clock time t3 is reached, a failure of the pressure sensor 70a is sensed by processing by the pressure sensor failure sensing section 57d to be described later.

In a period from the clock time t3 to the clock time t5, the failure of the pressure sensor 70a has been sensed, and thus the differential pressures across the selector valves 47a and 49a are calculated by using the pseudo-pressure calculated by the pseudo-pressure computation section 57e instead of the measurement value of the pressure sensor 70a. By using the pseudo-pressure instead of the measurement value of the pressure sensor 70a involving the failure, the pressure of the closed-circuit pumps 16 and 18 can be prevented from being excessively raised. Therefore, shock when the selector valve 47a or 49a is opened can be suppressed.

FIG. 5 is a flowchart illustrating part of the processing executed by the pressure sensor failure sensing section 57d. In FIG. 5, only processing of sensing a failure of the pressure sensor 70a of the boom cylinder 1 is illustrated. The failure sensing for the pressure sensor 70a of the boom cylinder 1 is executed by comparing the measurement value of the pressure sensor 70a with the measurement values of the pressure sensors 80a, 82a, 84a, and 86a of the closed-circuit pumps 12, 14, 16, and 18 connected to the boom cylinder 1 by the same line and the pressure sensors 81, 83, 85, and 87 of the open-circuit pumps 13, 15, 17, and 19. Note that, in FIG. 5, processing of comparison with the measurement values of the pressure sensors 81, 83, 85, and 87 of the open-circuit pumps 13, 15, 17, and 19 is omitted. The respective steps in FIG. 5 will be sequentially described below.

First, the pressure sensor failure sensing section 57d determines whether the boom cylinder 1 and the closed-circuit pump 12 are connected or not (step S11). When a determination of YES is made in the step S11, a transition to a step S21 to be described later is made. When a determination of YES is made in the step S11, the absolute value of the difference in the measurement value (differential pressure) between the pressure sensors 70a and 80a is calculated (step S12). Subsequently to the step S12, whether the differential pressure is lower than a predetermined threshold Plim is determined (step S13). Here, the threshold Plim is a value settled in advance in consideration of the measurement error of the pressure sensor and the flow rate pressure loss characteristics. Furthermore, although a constant value is employed as the threshold Plim in the present embodiment, a value that changes depending on the pump delivery flow rate may be employed. When a determination of NO is made in the step S13, a transition to the step S21 to be described later is made. When a determination of NO is made in the step S13, 1 is added to a failure flag of the pressure sensor 70a (step S14).

Subsequently to the step S14, whether the boom cylinder 1 and the closed-circuit pump 14 are connected or not is determined (step S21). When a determination of YES is made in the step S21, the absolute value of the difference in the measurement value (differential pressure) between the pressure sensors 70a and 82a is calculated (step S22). Subsequently to the step S22, whether the differential pressure is lower than the threshold Plim is determined (step S23). When a determination of NO is made in the step S23, a transition to a step S31 to be described later is made. When a determination of NO is made in the step S23, 1 is added to the failure flag of the pressure sensor 70a (step S24).

Subsequently to the step S24, whether the boom cylinder 1 and the closed-circuit pump 16 are connected or not is determined (step S31). When a determination of YES is made in the step S31, the absolute value of the difference in the measurement value (differential pressure) between the pressure sensors 70a and 84a is calculated (step S32). Subsequently to the step S32, whether the differential pressure is lower than the threshold Plim is determined (step S33). When a determination of NO is made in the step S33, a transition to a step S41 to be described later is made. When a determination of NO is made in the step S33, 1 is added to the failure flag of the pressure sensor 70a (step S34).

Subsequently to the step S34, whether the boom cylinder 1 and the closed-circuit pump 18 are connected or not is determined (step S41). When a determination of YES is made in the step S41, the absolute value of the difference in the measurement value (differential pressure) between the pressure sensors 70a and 86a is calculated (step S42). Subsequently to the step S42, whether the differential pressure is lower than the threshold Plim is determined (step S43). When a determination of NO is made in the step S43, a transition to a step S51 to be described later is made. When a determination of NO is made in the step S43, 1 is added to the failure flag of the pressure sensor 70a (step S44).

Subsequently to the step S44, whether the failure flag is larger than 1 is determined (step S51). When a determination of NO is made in the step S51, this flow is ended. When a determination of YES is made in the step S51, it is determined that the pressure sensor 70a involves a failure (step S52), and this flow is ended.

Although the processing relating to the failure sensing for the pressure sensor 70a has been described above, the pressure sensor failure sensing section 57d can also sense a failure of the other actuator pressure sensors 70b, 71a, 71b, 72a, 72b, 73a, and 73b and the pump pressure sensors 80a, 80b, 81, 82a, 82b, 83, 84a, 84b, 85, 86a, 86b, and 87 by comparing the measurement values regarding each combination of two pressure sensors included in three or more pressure sensors that are sensing the pressure of a line in a communicating state.

With reference to FIG. 4, description will be given about failure sensing operation when the pressure sensor 70a that measures the cap chamber pressure of the boom cylinder 1 is normal and when the pressure sensor 70a involves a failure.

### <When Pressure Sensor 70a is Normal>

In the state of the selector valves 43a, 45a, 47a, and 49a being open from the clock time t1 to the clock time t5, whether the boom cylinder 1 and the closed-circuit pump 12, 14, 16, or 18 are connected or not is determined in the steps S11, S21, S31, and S41. When they are connected, the differential pressure between the pressure of the boom cylinder 1 and the pressure of the pump 12, 14, 16, or 18 is calculated in S12, S22, S32, and S42. At this time, the pressure sensor 70a is normal and the differential pressure from the pump pressure is lower than the threshold Plim. Thus, the failure flag of the pressure sensor 70a is not counted up. That is, the failure flag is zero. Therefore, it is not determined that the pressure sensor 70a involves a failure in the step S51.

### <When Pressure Sensor 70a Involves Failure>

In the state of the selector valves 43a, 45a, 47a, and 49a being open from the clock time t1 to the clock time t5, whether the boom cylinder 1 and the closed-circuit pump 12, 14, 16, or 18 are connected or not is determined in the steps S11, S21, S31, and S41. When they are connected, the differential pressure between the pressure of the boom cylinder 1 and the pressure of the pump 12, 14, 16, or 18 is calculated in the steps S12, S22, S32, and S42. At this time, the pressure sensor 70a involves a failure and the differential pressure from the pump pressure is higher than the threshold Plim. Thus, the failure flag of the pressure sensor 70a is counted up in the steps S14, S24, S34, and S44. After the clock time 2, in the situation in which two or more pumps are connected to the boom cylinder 1, the failure flag of the pressure sensor 70a becomes larger than 1, and thus it is determined that the pressure sensor 70a involves a failure in the step S51.

Next, processing by the pseudo-pressure computation section 57e illustrated in FIG. 3 will be described. The pseudo-pressure computation section 57e decides pseudo-pressure of the actuators 1, 3, and 5 that drive the work device 106, on the basis of the posture of the hydraulic excavator 100. The method of deciding the pseudo-pressure will be described below by taking the arm cylinder 3 as an example.

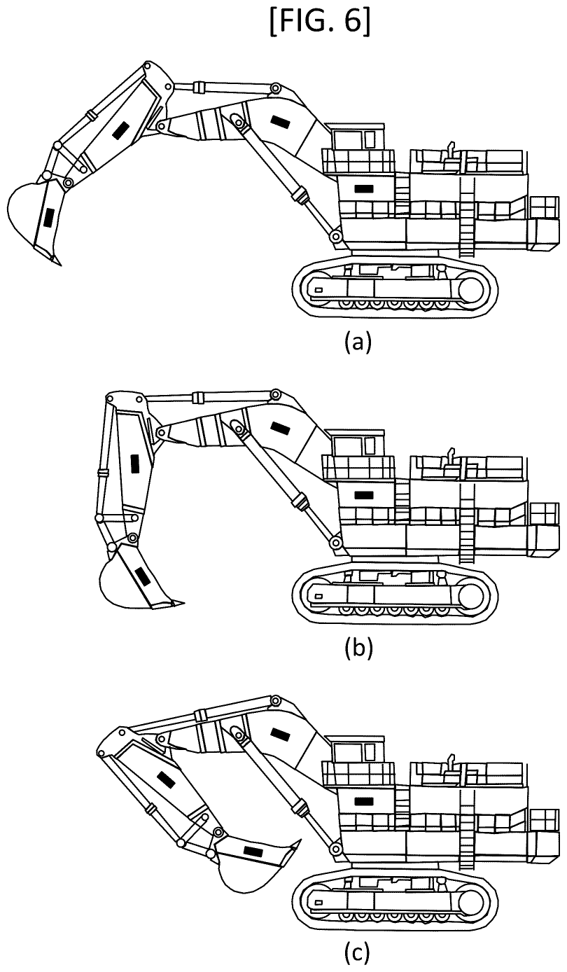

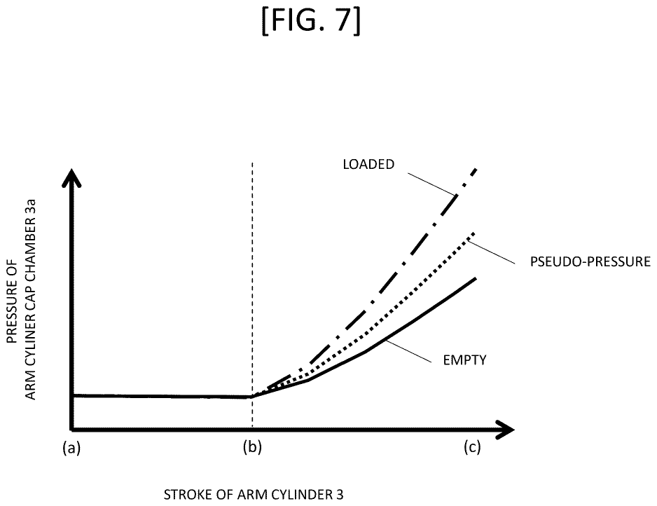

FIG. 6 illustrates posture change of the hydraulic excavator 100 when extension action of the arm cylinder 3 is caused. FIG. 7 illustrates the relationship between the stroke of the arm cylinder 3 and the pressure of the cap chamber 3a of the arm cylinder 3. With postures (a) to (b) in FIG. 6, the pressure of the cap chamber 3a of the arm cylinder 3 is constant as illustrated in FIG. 7. This is because, due to action of a force, which supports the arm 4 and the bucket 6 against the gravity, on the rod chamber 3b of the arm cylinder 3, the pressure of the rod chamber 3b becomes higher than the pressure of the cap chamber 3a, and the cap chamber 3a on the lower pressure side is kept at a charge pressure by the flushing valve 34. Therefore, it is sufficient to set the pseudo-pressure of the cap chamber 3a of the arm cylinder 3 to the charge pressure in the stroke range of postures (a) to (b).

With postures (b) to (c) in FIG. 6, the pressure of the cap chamber 3a of the arm cylinder 3 increases depending on the stroke as illustrated in FIG. 7. This is because the force necessary to support the arm 4 and the bucket 6 against the gravity is produced. At this time, the pressure differs depending on whether the inside of the bucket 6 is empty or is loaded in a full state. In view of this characteristic, the pseudo-pressure is set to become a larger value than the pressure in the empty state (no-load state) with respect to the cylinder stroke in such a manner that the difference between the pseudo-pressure and the actual pressure may become small even in the loaded state. Note that, although description has been given about the case in which the posture of the boom cylinder 1, the bucket cylinder 5, and the upper swing structure 103 is constant posture as illustrated in FIG. 6 in the present embodiment, a table of the pseudo-pressure is also included regarding the case in which the posture of the actuators other than the arm cylinder 3 and the upper swing structure 103 is varied.

Due to providing the controller 57 with the functions illustrated in FIG. 3, even when the actuator pressure sensor 70a to 73b involves a failure, the hydraulic excavator 100 can be operated without significantly lowering the operability by calculating the differential pressures across the selector valves 43a to 50d by using the pseudo-pressure. Furthermore, information displayed by the display device 58 makes the operator recognize the failure state of the pressure sensors and prompts the operator to execute early repair of the pressure sensor.

The pressure sensor failure diagnosis input generation device 59 illustrated in FIG. 3 causes the hydraulic excavator 100 to take predetermined diagnosis postures (for example, posture with which the pressure of the cap chamber 3a of the arm cylinder 3 becomes low like that in FIG. 6(a) and posture with which the pressure of the cap chamber 3a of the arm cylinder 3 becomes high like that in FIG. 6(c)). This enables comparison between the outputs of the normal pressure sensor and the pressure sensor involving a failure at various pressure levels, and improvement of the probability of the failure sensing. Moreover, differently from the case of sensing during operation, the accuracy of the failure sensing can be improved by comparing the outputs of the pressure sensors in the state in which the hydraulic excavator 100 stands still with the diagnosis posture, that is, in the state in which the influence of the flow rate pressure loss characteristics is eliminated and the pressure on the line is made even. Note that the pressure sensor failure diagnosis input generation device 59 may be configured as part of the functions of the controller 57 although being configured as a device independent of the controller 57 in the present embodiment.

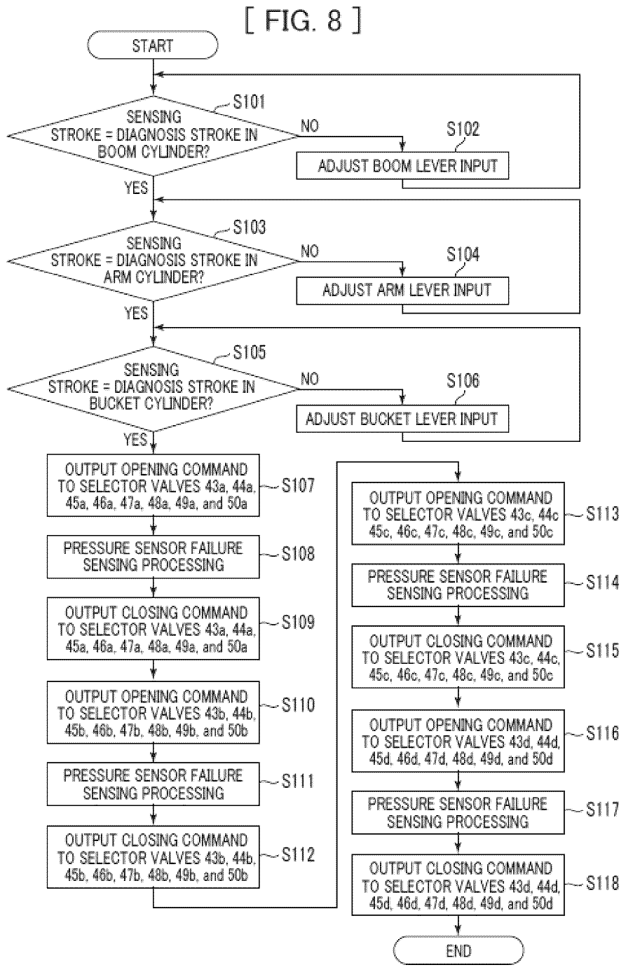

FIG. 8 is a flowchart illustrating processing executed by the pressure sensor failure diagnosis input generation device 59. The processing of this flow is executed in the state in which the hydraulic excavator 100 is set on a horizontal ground surface. The respective steps will be sequentially described below.

First, the pressure sensor failure diagnosis input generation device 59 calculates the stroke (sensing stroke) of the boom cylinder 1 from the measurement values of the posture sensors 400 to 403, and determines whether the sensing stroke corresponds with the stroke (diagnosis stroke) of the boom cylinder 1 with the diagnosis posture (step S101). When a determination of NO is made in the step S101, the input of the boom lever 56a is adjusted to decrease the difference between the sensing stroke and the diagnosis stroke (step S102), and the processing returns to the step S101. Here, the input of the boom lever 56a is adjusted to, for example, a value obtained by multiplying the difference between the diagnosis stroke and the sensing stroke by a predetermined gain. Furthermore, the predetermined gain is set to such a small value that two or more closed-circuit pumps are not connected to the boom cylinder 1. This enables the posture of the boom 2 to be gently changed toward the diagnosis posture.

When a determination of YES is made in the step S101, the stroke (sensing stroke) of the arm cylinder 3 is calculated from the measurement values of the posture sensors 400 to 403, and it is determined whether the sensing stroke corresponds with the stroke (diagnosis stroke) of the arm cylinder 3 with the diagnosis posture (step S103). When a determination of NO is made in the step S103, the input of the arm lever 56b is adjusted to decrease the difference between the sensing stroke and the diagnosis stroke (step S104), and the processing returns to the step S103. Here, the input of the arm lever 56b is adjusted to, for example, a value obtained by multiplying the difference between the diagnosis stroke and the sensing stroke by a predetermined gain. Moreover, the predetermined gain is set to such a small value that two or more closed-circuit pumps are not connected to the arm cylinder 3. This enables the posture of the arm 4 to be gently changed toward the diagnosis posture.

When a determination of YES is made in the step S103, the stroke (sensing stroke) of the bucket cylinder 5 is calculated from the measurement values of the posture sensors 400 to 403, and it is determined whether the sensing stroke corresponds with the stroke (diagnosis stroke) of the bucket cylinder 5 with the diagnosis posture (step S105). When a determination of NO is made in the step S105, the input of the bucket lever 56c is adjusted to decrease the difference between the sensing stroke and the diagnosis stroke (step S106), and the processing returns to the step S105. Here, the input of the bucket lever 56c is adjusted to, for example, a value obtained by multiplying the difference between the diagnosis stroke and the sensing stroke by a predetermined gain. Furthermore, the predetermined gain is set to such a small value that two or more closed-circuit pumps are not connected to the bucket cylinder 5. This enables the posture of the bucket 6 to be gently changed toward the diagnosis posture.

When a determination of YES is made in the step S105, the opening command is output to the selector valves 43a, 44a, 45a, 46a, 47a, 48a, 49a, and 50a (step S107). This causes execution of failure diagnosis processing by the pressure sensor failure sensing section 57d in the state in which the hydraulic excavator 100 stands still with the diagnosis posture and the closed-circuit pumps 12, 14, 16, and 18 are connected to the boom cylinder 1 (step S108).

Subsequently to the step S108, a closing command is output to the selector valves 43a, 44a, 45a, 46a, 47a, 48a, 49a, and 50a (step S109), and the opening command is output to the selector valves 43b, 44b, 45b, 46b, 47b, 48b, 49b, and 50b (step S110). This causes execution of the failure diagnosis processing by the pressure sensor failure sensing section 57d in the state in which the hydraulic excavator 100 stands still with the diagnosis posture and the closed-circuit pumps 12, 14, 16, and 18 are connected to the arm cylinder 3 (step S111).

Subsequently to the step S111, the closing command is output to the selector valves 43b, 44b, 45b, 46b, 47b, 48b, 49b, and 50b (step S112), and the opening command is output to the selector valves 43c, 44c, 45c, 46c, 47c, 48c, 49c, and 50c (step S113). This causes execution of the failure diagnosis processing by the pressure sensor failure sensing section 57d in the state in which the hydraulic excavator 100 stands still with the diagnosis posture and the closed-circuit pumps 12, 14, 16, and 18 are connected to the bucket cylinder 5 (step S114).

Subsequently to the step S114, the closing command is output to the selector valves 43c, 44c, 45c, 46c, 47c, 48c, 49c, and 50c (step S115), and the opening command is output to the selector valves 43d, 44d, 45d, 46d, 47d, 48d, 49d, and 50d (step S116). This causes execution of the failure diagnosis processing by the pressure sensor failure sensing section 57d in the state in which the hydraulic excavator 100 stands still with the diagnosis posture and the closed-circuit pumps 12, 14, 16, and 18 are connected to the swing motor 7 (step S117).

Subsequently to the step S117, the closing command is output to the selector valves 43d, 44d, 45d, 46d, 47d, 48d, 49d, and 50d (step S118), and this flow is ended.

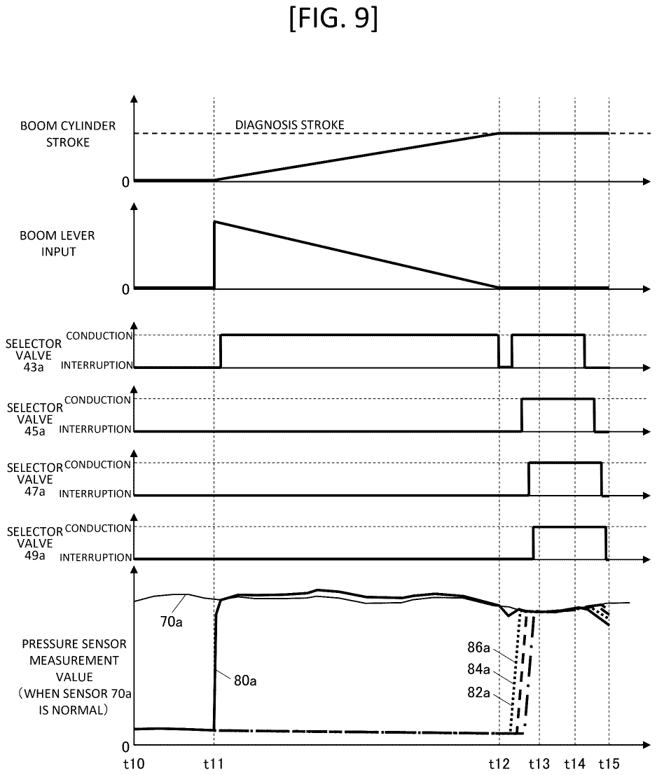

In FIG. 9, state change of the hydraulic drive system 107 depending on the input of the pressure sensor failure diagnosis input generation device 59 is illustrated. In FIG. 9, only operation at the time of failure diagnosis for the pressure sensor 70a on the cap side of the boom cylinder 1 is illustrated. Furthermore, it is assumed that the arm 4 and the bucket 6 have already taken the diagnosis posture.

From a clock time t10 to a clock time t11, the pressure sensor failure diagnosis input generation device 59 is not activated, and the input of the boom lever 56a is 0 and the boom cylinder 1 stands still.

The pressure sensor failure diagnosis input generation device 59 is activated at the clock time t11, and the input of the boom lever 56a is adjusted until the stroke of the boom cylinder 1 reaches the diagnosis stroke at a clock time t12. The selector valve 43a opens shortly after the start of the input of the boom lever 56a at the clock time t11, and the closed-circuit pump 12 is connected to the boom cylinder 1. The input of the boom lever 56a becomes smaller as the stroke of the boom cylinder 1 becomes closer to the diagnosis stroke.

The selector valve 43a is closed when the stroke of the boom cylinder 1 reaches the diagnosis stroke at the clock time t12. In a period from the clock time t12 to a clock time t13, the selector valves 43a, 45a, 47a, and 49a open.

Failure diagnosis for the pressure sensor 70a is executed in a period from the clock time t13 to a clock time t14, and the selector valves 43a, 45a, 47a, and 49a are closed in a period from the clock time t14 to a clock time t15.

### (Summarization)

In the present embodiment, a construction machine includes the work device 106, the actuators 1, 3, and 5 that drive the work device 106, the plurality of closed-circuit pumps 12, 14, 16, and 18 of the variable displacement type having two flow-out/in ports, the plurality of closed-circuit selector valves 43a to 43d, 45a to 45d, and 47a to 47d capable of switching between communication and interruption between the actuators 1, 3, and 5 and the plurality of closed-circuit pumps 12, 14, 16, and 18, the posture sensors 400 to 403 that sense the posture of the work device 106, the plurality of closed-circuit pump pressure sensors 80a, 80b, 82a, 82b, 84a, 84b, 86a, and 86b that sense the pressure of the plurality of closed-circuit pumps 12, 14, 16, and 18, the actuator pressure sensors 70a, 70b, 71a, 71b, 72a, and 72b that sense the pressure of the actuators 1, 3, and 5, the operation device 56 that instructs the actuators 1, 3, and 5 to act, and the controller 57 that controls the plurality of closed-circuit selector valves 43a to 43d, 45a to 45d, and 47a to 47d and the plurality of closed-circuit pumps 12, 14, 16, and 18 in response to an input signal from the operation device 56. In addition, when supply of the hydraulic operating fluid from one closed-circuit pump among the plurality of closed-circuit pumps 12, 14, 16, and 18 to the actuator 1, 3, or 5 is started, the controller 57 opens one closed-circuit selector valve corresponding to the one closed-circuit pump among the plurality of closed-circuit selector valves 43a to 43d, 45a to 45d, and 47a to 47d after controlling, in the state in which the one closed-circuit selector valve is closed, the one closed-circuit pump in such a manner that the differential pressure across the closed-circuit selector valve that is the difference between the measurement value of one closed-circuit pump pressure sensor corresponding to the one closed-circuit pump and the measurement value of the actuator pressure sensor 70a, 70b, 71a, 71b, 72a, or 72b becomes equal to or lower than the predetermined first threshold. In the construction machine, in the state in which two or more closed-circuit pumps among the plurality of closed-circuit pumps 12, 14, 16, and 18 are connected to the actuator 1, 3, or 5, the controller 57 determines whether a failure of the actuator pressure sensor 70a, 70b, 71a, 71b, 72a, or 72b exists on the basis of the measurement values of two or more closed-circuit pump pressure sensors corresponding to the two or more closed-circuit pumps among the plurality of closed-circuit pump pressure sensors 80a, 80b, 82a, 82b, 84a, 84b, 86a, and 86b and the measurement value of the actuator pressure sensor 70a, 70b, 71a, 71b, 72a, or 72b. When determining that the actuator pressure sensor 70a, 70b, 71a, 71b, 72a, or 72b involves a failure, the controller 57 calculates pseudo-pressure of the actuator 1, 3, or 5 on the basis of the measurement values of the posture sensors 400 to 403, and calculates the differential pressure across the closed-circuit selector valve by using the pseudo-pressure instead of the measurement value of the actuator pressure sensor 70a, 70b, 71a, 71b, 72a, or 72b.

According to the present embodiment configured as above, it becomes possible to correctly determine a failure of the actuator pressure sensor 70a, 70b, 71a, 71b, 72a, 72b, 73a, or 73b on the basis of the result of comparison between the measurement value of the actuator pressure sensor 70a, 70b, 71a, 71b, 72a, 72b, 73a, or 73b and the measurement values of the two or more closed-circuit pump pressure sensors. Furthermore, when the actuator pressure sensor 70a, 70b, 71a, 71b, 72a, or 72b involves a failure, the differential pressure across the closed-circuit selector valve 43a to 43d, 45a to 45d, or 47a to 47d is calculated by using the pseudo-pressure of the actuator 1, 3, or 5 calculated according to the posture of the work device 106 instead of the measurement value of the pressure sensor involving the failure. As a result, shock when the closed-circuit pump 12, 14, 16, or 18 is connected to the actuator 1, 3, or 5 is suppressed. Thus, the lowering of the operability can be prevented.

Moreover, the hydraulic excavator 100 in the present embodiment includes the plurality of open-circuit pumps 13, 15, 17, and 19 of the variable displacement type having a flow-in port and a flow-out port, the plurality of open-circuit selector valves 44a to 44d, 46a to 46d, 48a to 48d, and 50a to 50d capable of connecting the plurality of open-circuit pumps 13, 15, 17, and 19 to the actuators 1, 3, and 5, and the plurality of open-circuit pump pressure sensors 81, 83, 85, and 87 that sense the pressure of the plurality of open-circuit pumps 13, 15, 17, and 19. When supply of the hydraulic operating fluid from one open-circuit pump among the plurality of open-circuit pumps 13, 15, 17, and 19 to the actuator 1, 3, or 5 is started, the controller 57 opens one open-circuit selector valve corresponding to the one open-circuit pump among the plurality of open-circuit selector valves 44a to 44d, 46a to 46d, 48a to 48d, and 50a to 50d after controlling, in the state in which the one open-circuit selector valve is closed, the one open-circuit pump in such a manner that the differential pressure across the open-circuit selector valve that is the difference between the measurement value of one open-circuit pump pressure sensor corresponding to the one open-circuit pump and the measurement value of the actuator pressure sensor 70a, 70b, 71a, 71b, 72a, or 72b becomes equal to or lower than the first threshold. In the state in which two or more open-circuit pumps among the plurality of open-circuit pumps 13, 15, 17, and 19 are connected to the actuator 1, 3, or 5, the controller 57 determines whether a failure of the actuator pressure sensor 70a, 70b, 71a, 71b, 72a, or 72b exists on the basis of the measurement values of two or more open-circuit pump pressure sensors corresponding to the two or more open-circuit pumps among the plurality of open-circuit pump pressure sensors 81, 83, 85, and 87 and the measurement value of the actuator pressure sensor 70a, 70b, 71a, 71b, 72a, or 72b. When determining that the actuator pressure sensor 70a, 70b, 71a, 71b, 72a, or 72b involves a failure, the controller 57 calculates the differential pressure across the open-circuit selector valve by using the pseudo-pressure instead of the measurement value of the actuator pressure sensor 70a, 70b, 71a, 71b, 72a, or 72b. This enables correct determination of a failure of the actuator pressure sensor 70a, 70b, 71a, 71b, 72a, 72b, 73a, or 73b on the basis of the result of comparison between the measurement value of the actuator pressure sensor 70a, 70b, 71a, 71b, 72a, 72b, 73a, or 73b and the measurement values of the two or more open-circuit pump pressure sensors. Furthermore, when the actuator pressure sensor 70a, 70b, 71a, 71b, 72a, or 72b involves a failure, the differential pressure across the open-circuit selector valve 44a to 44d, 46a to 46d, or 48a to 48d is calculated by using the pseudo-pressure of the actuator 1, 3, or 5 calculated according to the posture of the work device 106 instead of the measurement value of the pressure sensor involving the failure. As a result, shock when the open-circuit pump 13, 15, 17, or 19 is connected to the actuator 1, 3, or 5 is suppressed. Thus, the lowering of the operability can be prevented.

Moreover, the controller 57 in the present embodiment calculates the difference in the measurement value regarding each combination of two pressure sensors included in the actuator pressure sensors 70a to 72b, the two or more closed-circuit pump pressure sensors, and the two or more open-circuit pump pressure sensors in the state in which the two or more closed-circuit pumps and the two or more open-circuit pumps are connected to the actuator 1, 3, or 5, and determines that the pressure sensor included in two or more combinations in which the difference is larger than the predetermined second threshold Plim involves a failure. This enables sensing of a failure of the closed-circuit pump pressure sensors 80a, 80b, 82a, 82b, 84a, 84b, 86a, and 86b and the open-circuit pump pressure sensors 81, 83, 85, and 87 in addition to the actuator pressure sensors 70a to 72b.

Furthermore, the hydraulic excavator 100 in the present embodiment includes the display device 58 capable of displaying information output from the controller 57. The controller 57 outputs, to the display device 58, identification information of one pressure sensor included in the actuator pressure sensors 70a, 70b, 71a, 71b, 72a, and 72b, the two or more closed-circuit pump pressure sensors, and the two or more open-circuit pump pressure sensors when determining that the one pressure sensor involves a failure. This enables the time, which is taken until the pressure sensor involving a failure is corrected or replaced, to be shortened.

Moreover, the controller 57 in the present embodiment calculates the pseudo-pressure in such a manner that the pseudo-pressure has a larger value than the pressure of the actuator 1, 3, or 5 when the work device 106 takes posture sensed by the posture sensors 400 to 403 in a no-load state. This enables shock to be suppressed when the selector valve 43a to 49d is opened even in a case in which the actuator pressure sensor 70a, 70b, 71a, 71b, 72a, 72b, 73a, or 73b involves a failure in the state in which a load is applied to the work device 106.

Furthermore, the hydraulic excavator 100 in the present embodiment includes the pressure sensor failure diagnosis input generation device 59 capable of adjusting input and output of the controller 57. The controller 57 keeps the state in which the plurality of closed-circuit pumps 12, 14, 16, and 18 are connected to the actuator 1, 3, or 5 in the state in which the delivery flow rate of the plurality of closed-circuit pumps 12, 14, 16, and 18 is set to zero after controlling the plurality of closed-circuit pumps 12, 14, 16, and 18 and the plurality of closed-circuit selector valves to cause the work device 106 to take the predetermined posture (diagnosis posture), through adjustment of the input and the output by the pressure sensor failure diagnosis input generation device 59. Due to this, the failure diagnosis processing for the pressure sensor is executed in the state in which the hydraulic excavator 100 stands still with the diagnosis posture, that is, in the state in which the influence of the flow rate pressure loss characteristics is eliminated and the pressure on the line is made even. Thus, the accuracy of the failure sensing can be improved.

Although the embodiments of the present invention have been described in detail above, the present invention is not limited to the above-described embodiments and various modifications are included therein. For example, the above-described embodiments have been explained in detail in order to explain the present invention in an easy-to-understand manner, and the present invention is not necessarily limited to that including all configurations explained.

### DESCRIPTION OF REFERENCE CHARACTERS

1: Boom cylinder (actuator)
1a: Cap chamber
1b: Rod chamber
1c: Rod
1d: Cylinder tube
1e: Piston
2: Boom
3: Arm cylinder (actuator)
3a: Cap chamber
3b: Rod chamber
3c: Rod
3d: Cylinder tube
3e: Piston
4: Arm
5: Bucket cylinder (actuator)
5a: Cap chamber
5b: Rod chamber
5c: Rod
5d: Cylinder tube
5e: Piston
6: Bucket
7: Swing motor (actuator)
8a, 8b: Travelling motor
9: Engine
10: Power transmission device
11: Charge pump
12: First closed-circuit pump
12a: Regulator
13: First open-circuit pump
13a: Regulator
14: Second closed-circuit pump
14a: Regulator
15: Second open-circuit pump
15a: Regulator
16: Third closed-circuit pump
16a: Regulator
17: Third open-circuit pump
17a: Regulator
18: Fourth closed-circuit pump
18a: Regulator
19: Fourth open-circuit pump
19a: Regulator
20: Charge relief valve
21 to 24: Relief valve
25: Hydraulic operating fluid tank
26 to 29: Charge check valve
30a, 30b, 31a, 31b, 32a, 32b, 33a, 33b: Relief valve
34 to 36: Flushing valve
37a, 37b, 38a, 38b, 39a, 39b: Relief valve
40a, 40b, 41a, 41b, 42a, 42b: Charge check valve
43a to 43d, 45a to 45d, 47a to 47d, 49a to 49d: Selector valve (closed-circuit selector valve)
44a to 44d, 46a to 46d, 48a to 48d, 50a to 50d: Selector valve (open-circuit selector valve)
51a, 51b, 52a, 52b, 53a, 53b: Relief valve
54, 55: Proportional selector valve
56: Operation device
56a: Boom lever
56b: Arm lever
56c: Bucket lever
56d: Swing lever
57: Controller
57a: Lever operation amount computation section
57b: Pressure computation section
57c: Actuator-allocated flow rate computation section
57d: Pressure sensor failure sensing section
57e: Pseudo-pressure computation section
58: Display device
59: Pressure sensor failure diagnosis input generation device
64 to 67: Proportional valve
70a, 70b, 71a, 71b, 72a, 72b, 73a, 73b: Pressure sensor (actuator pressure sensor)
80a, 80b, 82a, 82b, 84a, 84b, 86a, 86b: Pressure sensor (closed-circuit pump pressure sensor)
81, 83, 85, 87: Pressure sensor (open-circuit pump pressure sensor)
100: Hydraulic excavator
101: Cab
101a, 101b: Track device
102: Lower track structure
103: Upper swing structure
104: Cab
105: Swing device
106: Front work implement (work device)
107: Hydraulic drive system
200 to 202: Flow line
202a: Branch flow line
203 to 205: Flow line
205a: Branch flow line
206 to 208: Flow line
208a: Branch flow line
209 to 211: Flow line
211a: Branch flow line
212 to 225: Flow line
301 to 304: Coupling flow line
305a to 305d, 306a to 306d, 307a to 307d, 308a to 308d: Connection flow line for the open circuit
309a to 309c: Connection flow line for the closed circuit
400 to 403: Posture sensor
A to D: Closed circuit
E to H: Open circuit

1. A construction machine comprising:
a work device;
an actuator that drives the work device;
a plurality of closed-circuit pumps of a variable displacement type having two flow-out/in ports;
a plurality of closed-circuit selector valves capable of switching between communication and interruption between the actuator and the plurality of closed-circuit pumps;
a posture sensor that senses posture of the work device;
a plurality of closed-circuit pump pressure sensors that sense pressure of the plurality of closed-circuit pumps ;
an actuator pressure sensor that senses pressure of the actuator;
an operation device that instructs the actuator to act; and
a controller that controls the plurality of closed-circuit selector valves and the plurality of closed-circuit pumps in response to an input signal from the operation device,
the controller being configured to, when supply of a hydraulic operating fluid from one closed-circuit pump among the plurality of closed-circuit pumps to the actuator is started, open one closed-circuit selector valve corresponding to the one closed-circuit pump among the plurality of closed-circuit selector valves after controlling, in a state in which the one closed-circuit selector valve is closed, the one closed-circuit pump in such a manner that differential pressure across the closed-circuit selector valve that is a difference between a measurement value of one closed-circuit pump pressure sensor corresponding to the one closed-circuit pump and a measurement value of the actuator pressure sensor becomes equal to or lower than a predetermined first threshold, wherein
the controller is configured to,
in a state in which two or more closed-circuit pumps among the plurality of closed-circuit pumps are connected to the actuator, determine whether a failure of the actuator pressure sensor exists on a basis of measurement values of two or more closed-circuit pump pressure sensors corresponding to the two or more closed-circuit pumps among the plurality of closed-circuit pump pressure sensors and the measurement value of the actuator pressure sensor, and
when determining that the actuator pressure sensor involves a failure, calculate pseudo-pressure of the actuator on a basis of a measurement value of the posture sensor, and calculate the differential pressure across the closed-circuit selector valve by using the pseudo-pressure instead of the measurement value of the actuator pressure sensor.

2. The construction machine according to claim 1, wherein
the construction machine includes
a plurality of open-circuit pumps of a variable displacement type having a flow-in port and a flow-out port,
a plurality of open-circuit selector valves capable of connecting the plurality of open-circuit pumps to the actuator, and
a plurality of open-circuit pump pressure sensors that sense pressure of the plurality of open-circuit pumps, and
the controller is configured to,
when supply of the hydraulic operating fluid from one open-circuit pump among the plurality of open-circuit pumps to the actuator is started, open one open-circuit selector valve corresponding to the one open-circuit pump among the plurality of open-circuit selector valves after controlling, in a state in which the one open-circuit selector valve is closed, the one open-circuit pump in such a manner that differential pressure across the open-circuit selector valve that is a difference between a measurement value of one open-circuit pump pressure sensor corresponding to the one open-circuit pump and the measurement value of the actuator pressure sensor becomes equal to or lower than the first threshold,
in a state in which two or more open-circuit pumps among the plurality of open-circuit pumps are connected to the actuator, determine whether a failure of the actuator pressure sensor exists on a basis of measurement values of two or more open-circuit pump pressure sensors corresponding to the two or more open-circuit pumps among the plurality of open-circuit pump pressure sensors and the measurement value of the actuator pressure sensor, and
when determining that the actuator pressure sensor involves a failure, calculate the differential pressure across the open-circuit selector valve by using the pseudo-pressure instead of the measurement value of the actuator pressure sensor.

3. The construction machine according to claim 2, wherein
the controller is configured to calculate a difference in a measurement value regarding each combination of two pressure sensors included in the actuator pressure sensor, the two or more closed-circuit pump pressure sensors, and the two or more open-circuit pump pressure sensors in a state in which the two or more closed-circuit pumps and the two or more open-circuit pumps are connected to the actuator, and determine that the pressure sensor included in two or more combinations in which the difference is larger than a predetermined second threshold involves a failure.

4. The construction machine according to claim 3, wherein
the construction machine includes a display device capable of displaying information output from the controller, and
the controller is configured to output, to the display device, identification information of one pressure sensor included in the actuator pressure sensor, the two or more closed-circuit pump pressure sensors, and the two or more open-circuit pump pressure sensors when determining that the one pressure sensor involves a failure.

5. The construction machine according to claim 1, wherein
the controller is configured to calculate the pseudo-pressure in such a manner that the pseudo-pressure has a value equal to or higher than pressure of the actuator when the work device takes posture sensed by the posture sensor in a no-load state.

6. The construction machine according to claim 1, wherein
the construction machine includes a pressure sensor failure diagnosis input generation device capable of adjusting input and output of the controller, and
the controller is configured to keep a state in which the plurality of closed-circuit pumps are connected to the actuator in a state in which a delivery flow rate of the plurality of closed-circuit pumps is set to zero after controlling the plurality of closed-circuit pumps and the plurality of closed-circuit selector valves to cause the work device to take predetermined posture, through adjustment of the input and the output by the pressure sensor failure diagnosis input generation device.
